(19) United States
(12) Patent Application Publication
(10) Pub. No.: US 2019/0089571 A1
(43) Pub. Date: Mar. 21, 2019

(54) Adaptive Backscatter Modulation

(71) Applicant: Qualcomm Incorporated, San Diego, CA (US)

(72) Inventors: William Henry Von Novak, III, San Diego, CA (US); Linda Irish, San Diego, CA (US)

(21) Appl. No.: 15/710,463

(22) Filed: Sep. 20, 2017

(51) Int. Cl. H04L 27/26; H04L 27/34

(52) U.S. Cl. CPC H04L 27/2694; H04L 2027/0097; H04L 27/2691; H04L 27/3472

(57) ABSTRACT

A wireless apparatus is disclosed for adapting a modulation scheme used with backscatter signaling. In an example aspect, the wireless apparatus includes a transceiver assembly, coupling analysis circuitry, modulation determination circuitry, and modulation application circuitry. In operation, the transceiver assembly receives a power transmission from another wireless apparatus via an inductive coupling link. The coupling analysis circuitry determines an inductive coupling quality associated with the inductive coupling link extending between the wireless apparatus and the other wireless apparatus. The modulation determination circuitry determines a modulation scheme based on the inductive coupling quality. The modulation application circuitry adjusts an impedance of the wireless apparatus in accordance with the determined modulation scheme. The transceiver assembly reflects a backscatter signal across the inductive coupling link using the power transmission and based on the impedance as adjusted in accordance with the determined modulation scheme.

### TECHNICAL FIELD

This disclosure relates generally to backscatter signaling that can be used to communicate between wireless apparatuses and, more specifically, to adapting a modulation scheme used to modulate a backscatter signal that is reflected from a power transmission.

### BACKGROUND

Wireless charging enables a base apparatus to wirelessly provide power to a mobile or other battery-powered apparatus. Battery-powered apparatuses include smaller, hand-held devices and larger, heavier devices. Examples of battery-powered apparatuses include smart phones, notebook computers, power tools, industrial equipment, robots, and vehicles, such as bicycles, cars, and trucks. Wireless charging can be accomplished, for example, using an electromagnetic (EM) field that establishes an inductive coupling between a charger device that transmits wireless power and a charging device that receives wireless power.

Wireless charging is becoming more prevalent because it allows for battery charging without the hassle of a charging cable and with a lower risk of mechanical failure. However, if a charging cable is not used to connect the charger device to the charging device, there is no available wire to be used for wired communications between the two devices during charging. Generally, unidirectional or bidirectional communications can fulfill a number of purposes between a charger device and a charging device. For example, in one direction, the charger device can provide program or data updates to the charging device. In the other direction, the charging device can forward sensor observations or performance logs to the charger device for local analysis or for forwarding to a cloud service. In addition, the management of the charging session may be controlled via the bidirectional communications.

In one approach for a wireless power environment, backscatter signaling is employed for communications originating from a charging device and flowing to a charger device. Backscatter communications are used with radio-frequency identification (RFID) technology, such as for “reverse link” communications (e.g., for communications from a passive RFID device to an active RFID device). In wireless charging environments, some systems also use backscatter communications for the reverse link via the inductive coupling created between the charger device and the charging device. For instance, systems supporting the “Qi Wireless Power” standard employ unidirectional backscatter communications that flow from the charging device to the charger device to create a reverse link. Unfortunately, certain backscatter communications techniques may be slow and error prone.

In another approach for a wireless power environment, a separate wireless channel is used for communications in addition to the wireless power channel. For example, a separate radio frequency (RF) or infrared channel can be used to exchange information between the charger and charging devices. With this approach, both the charger device and the charging device include at least one extra component to enable the transmission or reception of an RF or infrared signal using an out-of-band channel. Unfortunately, these extra components add to the cost, size, and complexity of both the charger device and the charging device.

### SUMMARY

A wireless apparatus is disclosed for adapting a modulation scheme used with backscatter signaling. In an example aspect, the wireless apparatus includes a transceiver assembly, coupling analysis circuitry, modulation determination circuitry, and modulation application circuitry. The transceiver assembly is configured to receive a power transmission from another wireless apparatus via an inductive coupling link. The coupling analysis circuitry is configured to determine an inductive coupling quality of the inductive coupling link. The modulation determination circuitry is configured to determine a modulation scheme based on the inductive coupling quality. The modulation application circuitry is configured to adjust an impedance in accordance with the modulation scheme. The transceiver assembly is further configured to reflect a backscatter signal across the inductive coupling link based on the impedance adjusted in accordance with the modulation scheme.

In an example aspect, a method for a subordinate wireless apparatus to adaptively modulate backscatter signaling is disclosed. The method includes receiving a power transmission from a primary wireless apparatus via an inductive coupling link. The method also includes determining an inductive coupling quality of the inductive coupling link. The method additionally includes determining a modulation scheme from multiple modulation schemes based on the inductive coupling quality. The method further includes reflecting, based on the modulation scheme, a backscatter signal across the inductive coupling link using the power transmission, which reflecting includes establishing an impedance at the subordinate wireless apparatus in accordance with an impedance point of the modulation scheme.

In an example aspect, a wireless apparatus is disclosed. The wireless apparatus includes a power store and a transceiver assembly. The power store is configured to provide or receive power. The transceiver assembly is configured to receive a power transmission from another wireless apparatus that has an inductive coupling link with the wireless apparatus at some inductive coupling quality. The transceiver assembly is also configured to provide to the power store power received via the power transmission. The transceiver assembly is further configured to reflect a backscatter signal across the inductive coupling link based on an impedance adjusted in accordance with a modulation scheme. The wireless apparatus also includes means for controlling the modulation scheme based on the inductive coupling quality to adjust a communication bandwidth between the wireless apparatus and the other wireless apparatus.

In an example aspect, a wireless apparatus is disclosed. The wireless apparatus includes a transceiver assembly and a transceiver controller. The transceiver assembly is configured to generate a power transmission and receive a backscatter signal reflected using the power transmission via an inductive coupling link. The backscatter signal carries information based on a modulation scheme. The transceiver controller is configured to analyze the backscatter signal to produce detected impedances respectively corresponding to impedance points in accordance with the modulation scheme. The transceiver controller is further configured to process the impedance points based on the modulation scheme to recover the information. The transceiver controller includes modulation control circuitry, which is configured to compute an error indication based on the information recovered by the transceiver controller.

In an example aspect, a wireless apparatus is disclosed. The wireless apparatus includes a transceiver assembly. The transceiver assembly is configured to generate a power transmission and receive a backscatter signal that is reflected from another wireless apparatus via an inductive coupling link using the power transmission. The backscatter signal carries information based on a selected modulation scheme of multiple modulation schemes. The wireless apparatus also includes means for controlling the transceiver to recover the information from the backscatter signal based on detected impedances respectively corresponding to impedance points in accordance with the selected modulation scheme.

In an example aspect, a method for a primary wireless apparatus to adaptively recover information from backscatter signaling is disclosed. The method includes providing a power transmission to a subordinate wireless apparatus via an inductive coupling link extending between the primary wireless apparatus and the subordinate wireless apparatus. The method also includes detecting impedances from among multiple impedances generated by a backscatter signal that is a reflection of the power transmission made by the subordinate wireless apparatus via the inductive coupling link. The method additionally includes recovering information using the detected impedances in accordance with a current modulation scheme. The method further includes participating in a feedback loop with the subordinate wireless apparatus by providing an indication of communication error using the current modulation scheme to facilitate selection of a different modulation scheme.

### BRIEF DESCRIPTION OF DRAWINGS

FIG. 1 illustrates an example backscatter communications environment including a primary wireless apparatus and a subordinate wireless apparatus.

FIG. 2 illustrates an example subordinate wireless apparatus including modulation control circuitry to adapt a modulation scheme for a backscatter signal.

FIG. 3 illustrates an example wireless power environment in which a modulation scheme is adapted based on an inductive coupling quality between two wireless power apparatuses.

FIG. 4 illustrates example circuitry for a wireless power transmitter and a wireless power receiver that are inductively coupled.

FIG. 5 depicts an example of a constellation of impedance shift points that is achievable on a complex I-Q plane using impedance-based modulation with two apparatuses that are inductively coupled.

FIG. 6 illustrates an example of circuitry for a wireless power receiver, including an adjustable impedance circuit.

FIG. 7 depicts examples of different sizes of modulation constellations on a complex I-Q plane.

FIG. 8 depicts examples of different modulation constellations on a complex I-Q plane.

FIG. 9 illustrates an example of modulation control circuitry for a subordinate wireless apparatus.

FIG. 10 illustrates an example of coupling analysis circuitry and modulation determination circuitry of the modulation control circuitry of FIG. 9.

FIG. 11 depicts an example of a 4-12 modulation constellation that can be implemented using a rectifier as part of the adjustable impedance circuit of FIG. 6.

FIG. 12 illustrates an example alternative approach to detecting a reflected backscatter signal at a primary wireless apparatus.

FIG. 13 is a flow diagram illustrating an example process for adapting a modulation scheme for backscatter signaling.

FIG. 14 is a schematic diagram of an example wireless power transfer system in which adaptive backscatter modulation can be implemented.

### DETAILED DESCRIPTION

Wireless charging enables a wireless power transmitter to provide power to a wireless power receiver without using a charging capable. The wireless power transmitter beams power to the wireless power receiver, and the wireless power receiver can retain the received power in a power store like a battery. As used herein, the term “power store” includes power cells, batteries, capacitors, and so forth. Wireless charging systems are provided for many different types of products. Example products that can be implemented as a wireless power receiver include toothbrushes, smart watches, smart phones, tablet computers, notebook computers, power tools, industrial equipment, robots, medical devices, and vehicles, such as bicycles, cars, and trucks.

Some types of products, such as toothbrushes, are less likely to communicate significant quantities of information. Other types of products, however, are more likely to communicate sizable amounts of information. For example, a smart phone may receive large updates for multiple applications. An electric car may upload vehicle diagnostic information for analysis. A battery-powered robot may upload observed data, e.g., a drone may upload high-definition video. Further, medical devices, including implanted ones that are typically relatively small, may upload sensor readings or a lengthy operational log, or they may download a firmware update. In such scenarios, the absence of a charging cable can hinder the ability to establish communications between a wireless power transmitter and a wireless power receiver.

A wireless channel that is separate from a wireless power channel can be used to enhance communication opportunities without resorting to a wired cable. For example, a radio frequency (RF) or an infrared (IR) channel can be used to exchange information. However, implementing a separate wireless channel involves including separate hardware components in both the wireless power transmitter and the wireless power receiver. These separate hardware components add cost and complexity to the wireless power devices. Further, separate hardware components can also add size, which is constrained in some wireless power devices, such as smart phones, watches, and implanted medical devices.

A wireless power channel can be used to exchange information between a wireless power transmitter and a wireless power receiver. A forward link from the wireless power transmitter to the wireless power receiver is provided by modulating the electromagnetic (EM) signal directly. For the reverse link, on the other hand, backscatter communications can be employed. With backscatter communications, the wireless power receiver can effectively return a signal by reflecting a transmitted signal back to the wireless power transmitter. As used herein, such a reflected signal is called a “backscatter signal.” By modulating the backscatter signal to encode information, a backscatter signal carrying the encoded information is reflected from the wireless power receiver to the wireless power transmitter.

Backscatter communications can be implemented using RF signals that radiate between two apparatuses. For example, a passive radio frequency identification (RFID) tag can reflect a signal transmitted by an RFID reader with the reflected signal modulated to carry some information. Backscatter communications can also be implemented using near-field systems, including those with two apparatuses that are inductively coupled. Such near-field systems can also be used for wireless power transfer.

Reverse link communications can be implemented by modulating an impedance at a wireless power receiver in a near-field system using inductive coupling. A change to the impedance is reflected away from the receiver side as part of the EM field due to the inductive coupling. This reflected impedance change, which is a form of backscatter communication signaling, can be detected in the impedance at the wireless power transmitter. Techniques for modulating the backscatter-based reverse link may involve on-off control of a load to change the reflected impedance. Line encoding methods like non-return-to-zero (NRZ), Manchester, and biphase are then used to send data on the reverse link from the passive device back to the active device. Unfortunately, line encoding methods may be relatively slow and have a relatively low communication bandwidth. Further, because of the low communication bandwidth, it is difficult to implement strategies for error detection or correction.

More complicated, higher-bandwidth approaches to modulation can be used with a backscatter signal that is reflected via an inductive coupling. The backscatter signal is modulated with a higher-bandwidth modulation scheme using impedance changes at a wireless power receiver. However, if the wireless power receiver and the wireless power transmitter have a poor degree of inductive coupling, higher-bandwidth modulation schemes are likely to fail. Two devices may be poorly inductively coupled if, for example, the devices are not properly aligned physically, one of the devices is not properly tuned, and so forth. In these situations, attempting to use a complicated modulation scheme to achieve a higher-bandwidth transmission rate can actually create more communication errors or cause slower communications.

In contrast with other approaches, and to at least partially address the above-identified concerns with higher-bandwidth modulation schemes, example techniques described herein adaptively utilize different modulation schemes for backscatter communication signaling. A primary wireless apparatus is in communication with a subordinate wireless apparatus. The primary wireless apparatus is an active device, and the subordinate wireless apparatus is generally a passive device. Thus, the primary wireless apparatus sends a transmitted signal to the subordinate wireless apparatus, and the subordinate wireless apparatus reflects the transmitted signal as a backscatter signal. In some scenarios, the signals include EM waves that are radiated at radio frequencies in the far-field. In other scenarios, the signals include a magnetic field and a reflected impedance across an inductive coupling in the near-field.

In example implementations, a subordinate wireless apparatus includes a transceiver assembly, coupling analysis circuitry, modulation determination circuitry, an adjustable impedance circuit, and impedance control circuitry. The transceiver assembly receives a transmitted signal, such as a power transmission, from a primary wireless apparatus that is wirelessly coupled to the subordinate wireless apparatus. The coupling analysis circuitry determines a coupling quality, such as an inductive coupling quality (ICQ), between the two apparatuses. The modulation determination circuitry determines a modulation scheme based on the coupling quality.

The adjustable impedance circuit includes one or more circuit elements that are adjustable so as to change an impedance of the transceiver assembly at the subordinate wireless apparatus. The impedance control circuitry adjusts the impedance in accordance with the determined modulation scheme. The modulation scheme includes a modulation constellation having multiple impedance points, with each impedance point corresponding to a particular impedance value which can be established by the adjustable impedance circuit. The multiple impedance points can be distributed in one or more quadrants of a complex in-phase/quadrature (I/Q) plane. Based on the impedance as adjusted in accordance with the determined modulation scheme, the transceiver assembly reflects a backscatter signal responsive to the transmitted signal.

In certain implementations, the impedance control circuitry can adapt to different modulation schemes by adjusting the reflected impedance of the adjustable impedance circuit, which is coupled to an inductor of the transceiver assembly at the subordinate wireless apparatus. For example, a real impedance can be changed by adding or removing direct current (DC) loads. The real impedance can be further changed by driving power into the reflected signal. The ability to inject power into the modulation process can be dependent on a charge level of a power store. Thus, a size of an available modulation constellation can also be increased by using an active reverse link (e.g., impedance amplification) based on a state of the power store. Additionally, an impedance point of a modulation constellation can be achieved by adjusting an imaginary impedance (e.g., reactance) by changing a tuning of the transceiver assembly. For example, a parallel or series capacitance can be changed. An impedance point of a modulation constellation can also be achieved by adjusting an imaginary impedance using a rectifier. For example, a synchronous rectifier timing can be changed to shift a phase of a backscatter signal.

A wireless system can adapt modulation schemes based on a coupling quality of a wireless channel between a primary wireless apparatus and a subordinate wireless apparatus. At least at first, an initial coupling quality can be determined based on an inductive coupling constant (K) between primary and subordinate wireless apparatuses that are inductively coupled. The inductive coupling constant can be estimated based on a mutual inductance (M) between the two apparatuses. The mutual inductance (M), in turn, can be estimated based on a voltage at the subordinate wireless apparatus, assuming transmitter current, frequency, and transmitter coil inductance at the primary wireless apparatus are known. Subsequently, an updated or current coupling quality can be determined based on an error rate using one or more trials in a closed loop testing scenario implemented by the primary and subordinate wireless apparatuses.

Thus, an initial modulation scheme can be determined based on an inference of a likely coupling quality. Thereafter, an apparatus can switch to other modulation schemes having lower or higher potential bandwidths based on a current coupling quality as determined by a current error rate. In these manners, an apparatus of a wireless system can adapt a modulation scheme for a backscatter signal being reflected to another apparatus based on a coupling quality between the two apparatuses. Consequently, higher-bandwidth, more-reliable transmissions can be made using backscatter communications, while also avoiding the inclusion of extra components to support a separate wireless channel.

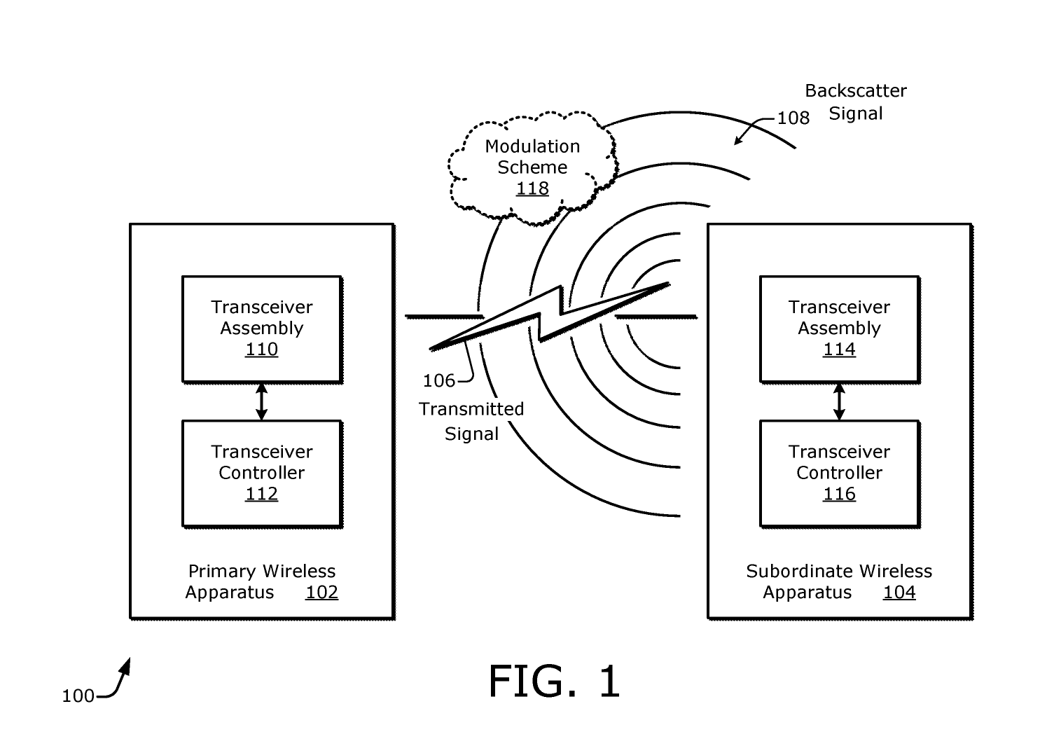

FIG. 1 illustrates an example backscatter communications environment 100 including a primary wireless apparatus 102 and a subordinate wireless apparatus 104. The primary wireless apparatus 102 includes a transceiver assembly 110 and a transceiver controller 112. The subordinate wireless apparatus 104 includes a transceiver assembly 114 and a transceiver controller 116. The backscatter communications environment 100 further includes a transmitted signal 106 and a backscatter signal 108. With the backscatter communications environment 100, communication from the primary wireless apparatus 102 to the subordinate wireless apparatus 104 is referred to as the forward link, and the primary wireless apparatus 102 is referred to as the active device. Conversely, communication from the subordinate wireless apparatus 104 to the primary wireless apparatus 102 is referred to as the reverse link, and the subordinate wireless apparatus 104 is generally referred to as the passive device.

For the primary wireless apparatus 102, the transceiver controller 112 controls operation of the transceiver assembly 110. Similarly for the subordinate wireless apparatus 104, the transceiver controller 116 controls operation of the transceiver assembly 114. The transceiver assembly 110 and the transceiver assembly 114 can transmit a signal or receive a signal. Generally, the transmitted signal 106 propagates between the primary wireless apparatus 102 and the subordinate wireless apparatus 104. The transmitted signal 106 can carry information, power, or both information and power.

In example operations, the transceiver assembly 110 transmits the transmitted signal 106 to the subordinate wireless apparatus 104 in accordance with control by the transceiver controller 112. Thus, the transceiver assembly 114 receives the transmitted signal 106 from the primary wireless apparatus 102. The transceiver controller 116 controls both reception and transmission by the transceiver assembly 114. For the backscatter communications environment 100, the transceiver controller 116 causes the transceiver assembly 114 to reflect the backscatter signal 108 based on the transmitted signal 106. The backscatter signal 108 can carry at least information based on a modulation scheme 118 that is used to generate the backscatter signal 108. Although the transmitted signal 106 is depicted with a lightning bolt and the backscatter signal 108 is depicted with concentric circles in FIG. 1, each of the signals may have any kind or degree of directionality, including omnidirectionality.

The backscatter communications environment 100 can be realized in many different types of wireless communication environments. For example, the primary wireless apparatus 102 and the subordinate wireless apparatus 104 can be inductively coupled via a magnetic field. Alternatively, the primary wireless apparatus 102 and the subordinate wireless apparatus 104 can communicate via a radiating electromagnetic (EM) signal, such as a radio frequency (RF) signal. For instance, many radio frequency identification (RFID) tags and corresponding RFID readers communicate using a backscatter signaling technique. Thus, the backscatter communications environment 100 can be implemented using near-field communications, inductive coupling systems, and so forth. In each case, the transceiver controller 116 employs some modulation scheme 118 to overlay information on the backscatter signal 108.

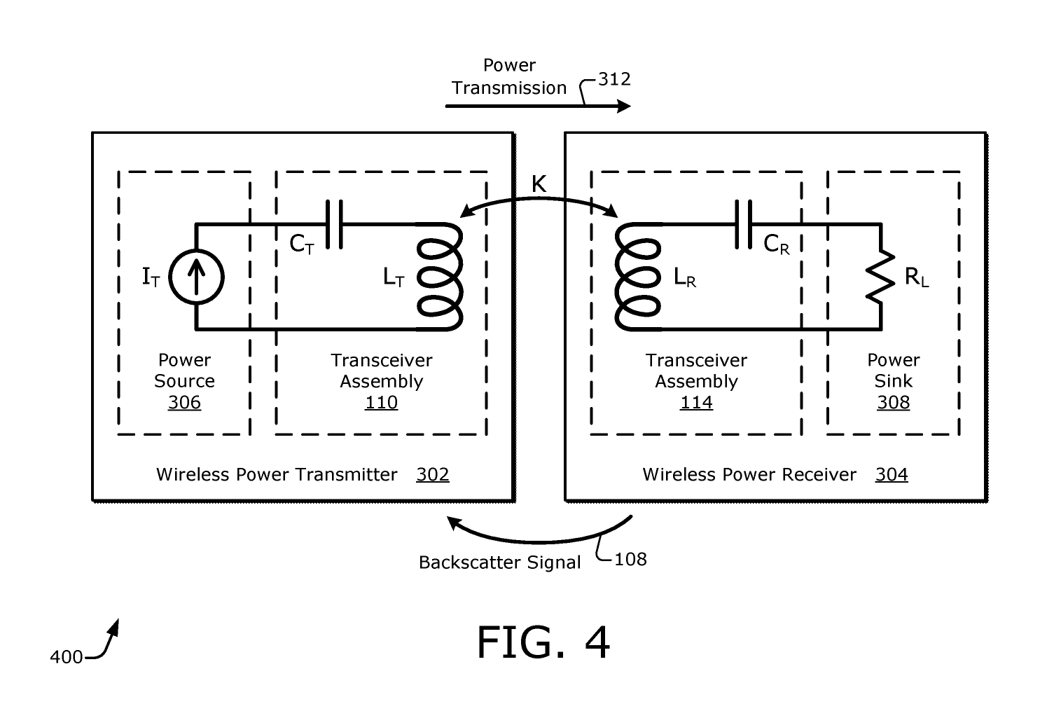

In some implementations, a transceiver assembly, such as a transceiver assembly 110 or 114, includes at least one of a transmitter or a receiver that respectively transmits or receives a wireless signal, such as an electromagnetic (EM) signal. Thus, a transceiver assembly can provide or detect a, e.g., magnetic signal communicated between two apparatuses. Example implementations for a transceiver assembly, as well as operations thereof, are described herein with reference to FIGS. 4, 6, and 9. Also, control circuitry or a controller, such as the transceiver controller 112 or 116, can be realized using a processing unit and processor-executable instructions that are stored on non-transitory processor-accessible media. Examples of a processing unit include a general-purpose processor, an application specific integrated circuit (ASIC), a microprocessor, a digital signal processor (DSP), hard-coded discrete logic, or a combination thereof. The processor-accessible media can include memory to retain the processor-executable instructions for software, firmware, hardware modules, and so forth. Memory may be volatile or nonvolatile memory, such as random access memory (RAM), read-only memory (ROM), flash memory, static RAM (SRAM), or a combination thereof. The processor-executable instructions can be implemented in accordance with the techniques and algorithms described herein.

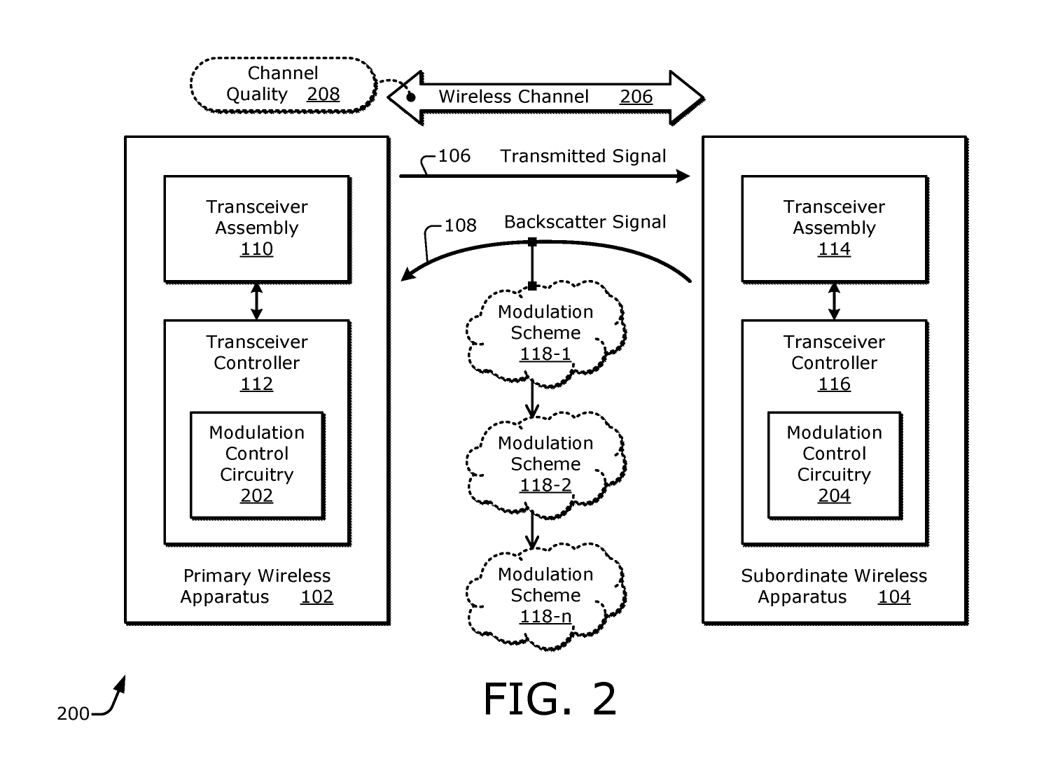

FIG. 2 illustrates an example backscatter communications system 200 including an example subordinate wireless apparatus 104 including modulation control circuitry 204 to adapt a modulation scheme 118 for a backscatter signal 108. As shown, the transceiver controller 112 of the primary wireless apparatus 102 includes modulation control circuitry 202, and the transceiver controller 116 of the subordinate wireless apparatus 104 includes the modulation control circuitry 204. Communications between the primary wireless apparatus 102 and the subordinate wireless apparatus 104 are exchanged across a wireless channel 206. The wireless channel 206 has an associated channel quality 208. The channel quality 208 refers to a channel state or condition that impacts how well a signal can be communicated over the wireless channel 206. The backscatter signal 108 is reflected over the wireless channel 206 using a modulation scheme 118 of multiple modulation schemes 118-1, 118-2 . . . 118-n. Although three modulation schemes 118-1, 118-2, and 118-n are explicitly depicted in FIG. 2, more or fewer modulation schemes may alternatively be implemented as indicated by the variable “n,” which represents any positive integer greater than one.

In example operations, the modulation control circuitry 204 determines a modulation scheme 118 that the transceiver assembly 114 uses to reflect the transmitted signal 106 as the backscatter signal 108. The currently-selected modulation scheme 118 controls how information is incorporated into the carrier portion of the backscatter signal 108 that is reflected over the wireless channel 206. Initially, a first modulation scheme 118-1 is selected, such as by default or by using a detected channel quality 208 of the wireless channel 206 that extends between the two apparatuses. The first modulation scheme 118-1 may be adequate to communicate information at a desired rate and may be usable given a current channel quality 208 of the wireless channel 206. If not, the modulation control circuitry 204 changes to a different modulation scheme, such as a second modulation scheme 118-2. Thus, the modulation control circuitry 204, alone or in conjunction with the modulation control circuitry 202, can control the modulation scheme 118 based on the coupling quality to adjust a communication bandwidth between the subordinate wireless apparatus 104 and the primary wireless apparatus 102.

To determine if a current channel quality 208 of the wireless channel 206 is of a sufficiently high level so as to permit usage of a given modulation scheme 118, the modulation control circuitry 204 can communicate with the modulation control circuitry 202 of the primary wireless apparatus 102. For example, a trial with the second modulation scheme 118-2 can be performed between the two apparatuses while a closed-loop feedback analysis is completed. The closed-loop feedback analysis can determine if a current error rate is less than a threshold error rate. If not, the modulation control circuitry 204 can change to yet another modulation scheme 118, such as a third modulation scheme 118-3 (not explicitly shown). With each modulation scheme change after a failed trial, the new modulation scheme 118 may provide a lower bandwidth but be capable of providing a lower error rate given a current channel quality 208 of the wireless channel 206.

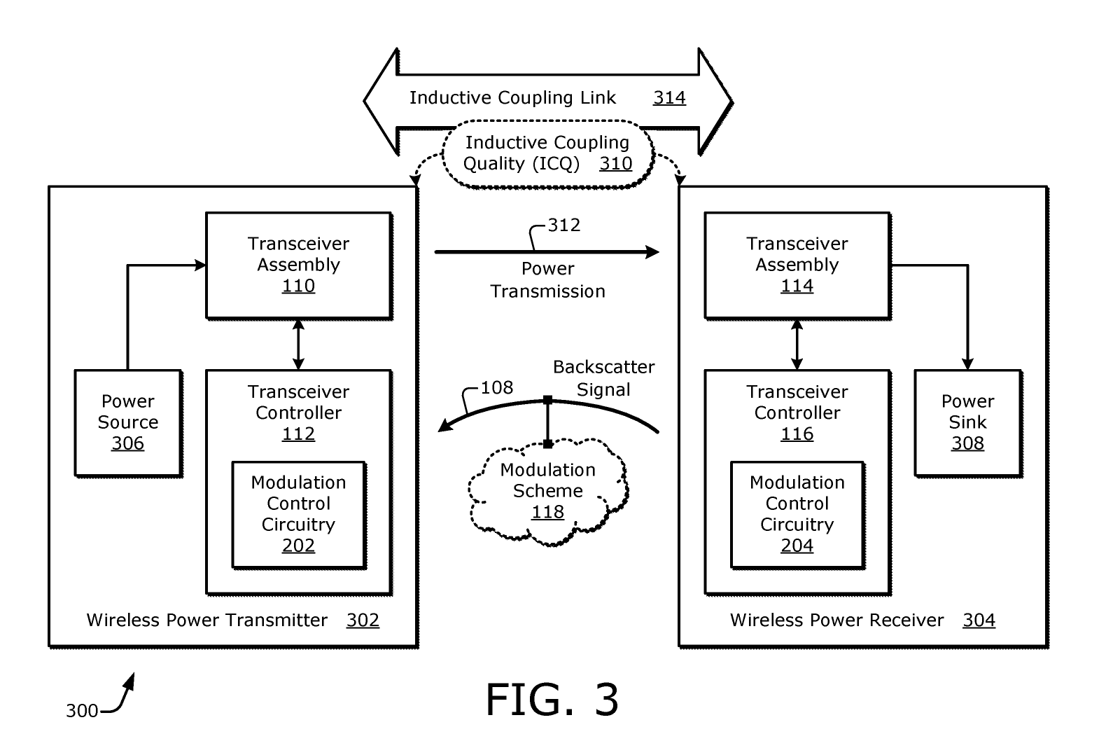

FIG. 3 illustrates an example wireless power environment 300 in which a modulation scheme 118 is adapted based on an inductive coupling quality 310 (ICQ) between two apparatuses. In the wireless power environment 300, the primary wireless apparatus 102 (e.g., of FIG. 2) is realized as a wireless power transmitter 302, and the subordinate wireless apparatus 104 is realized as a wireless power receiver 304. Further, the wireless channel 206 (also of FIG. 2) is realized as an inductive coupling link 314. Hence, the channel quality 208 is realized as the inductive coupling quality 310 for this wireless power environment 300. The wireless power transmitter 302 includes a power source 306, such as a chemical-based power generator, a solar array, an access point or socket coupling to an electrical grid, and so forth. The wireless power receiver 304 includes a power sink 308, such as a communications device, a motor, a power store (e.g., a battery or a capacitor), and so forth.

The power source 306 provides power to the transceiver assembly 110. The transceiver assembly 110 transforms the received power into a power transmission 312. The transceiver assembly 110 also sends the power transmission 312, which includes a power component can include an information component, over the inductive coupling link 314 to the transceiver assembly 114. The transceiver assembly 114 provides at least a portion of the power component of the power transmission 312 to the power sink 308. The power sink 308 uses the power component of the power transmission 312 to power the wireless power receiver 304 or to retain power for future use. The transceiver assembly 114 therefore functions as a receiver by receiving the power transmission 312 and functions as a transmitter by reflecting the backscatter signal 108 using the power transmission 312. The backscatter signal 108 can likewise include an information component or a power component.

In example implementations, the inductive coupling quality 310 represents how closely or how well the wireless power transmitter 302 can interact with the wireless power receiver 304. For example, the inductive coupling quality 310 can indicate how efficiently power can be transmitted from the wireless power transmitter 302 to the wireless power receiver 304, how accurately information can be reflected from the transceiver assembly 114 to the transceiver assembly 110, at what rate information can be reflected from the transceiver assembly 114 to the transceiver assembly 110, some combination thereof, and so forth. Generally, as the inductive coupling quality 310 increases, the ability to transfer information from the wireless power receiver 304 to the wireless power transmitter 302 likewise increases. Further, as the inductive coupling quality 310 becomes higher, the potential communication bandwidth also becomes higher. Thus, the modulation control circuitry 204 can determine a modulation scheme 118 that allows for a higher bit rate at an acceptable level of accuracy in accordance with a detected inductive coupling quality 310.

FIG. 4 illustrates example circuitry 400 for a wireless power transmitter 302 and a wireless power receiver 304 that are inductively coupled. The circuitry 400 includes circuitry for the transceiver assembly 110 and the power source 306 of the wireless power transmitter 302 and for the transceiver assembly 114 and the power sink 308 of the wireless power receiver 304. Each transceiver assembly includes an inductor (L) for inductive coupling and a capacitor (C) for tuning the transceiver. Together, the inductor (L) and the capacitor (C) in each transceiver assembly can create a resonant structure configured to resonant at some operating frequency. The transmitter and the receiver can be configured, for instance, to resonate at or near the same frequency to facilitate an inductive coupling.

In the illustrated example, the power source 306 is represented by a transmitter current source (I_{T}). The transceiver assembly 110 includes a transmitter capacitor (C_{T}) and a transmitter inductor (L_{T}) that are coupled together in series. The transmitter current source (I_{T}) is electrically coupled with the transceiver assembly 110. The power sink 308 is represented by a load resistance (R_{L}). The transceiver assembly 114 includes a receiver capacitor (C_{R}) and a receiver inductor (L_{R}) that are coupled together in series. The load resistance (R_{L}) is electrically coupled with the transceiver assembly 114.

To transfer power wirelessly, the wireless power transmitter 302 transmits the power transmission 312 (e.g., by generating a varying magnetic field) to the wireless power receiver 304 via an inductive coupling established between the transmitter inductor (L_{T}) and the receiver inductor (L_{R}), which can jointly operate similar to a transformer (e.g., albeit loosely coupled relative to the coils of a transformer). The coupling constant (K) represents the inductive coupling quality 310 (of FIG. 3) in this example inductive coupling scenario. The backscatter signal 108 is reflected from the transceiver assembly 114 to the transceiver assembly 110 via the inductive coupling. Information can be encoded onto the backscatter signal 108 based on an impedance of the wireless power receiver 304. The impedance can be established based on circuitry components of the transceiver assembly 114 or the power sink 308.

Generally, a wireless power receiver causes an impedance change as seen by a coil of a transmitter inductor (L_{T}) if the receiver is placed in sufficient proximity to the wireless power receiver to establish an inductive coupling. The amount or size of an impedance change detected by the transmitter can be influenced by a number of factors. First, the physical object of the receiver detunes the transmitter and causes a reactance change, which is typically negative (e.g., capacitive). Second, the losses in eddy currents in the case and coil of the receiver cause a real impedance change at the transmitter. This increases the impedance detected by the transmitter. Third, another factor that increases the real impedance detected by the transmitter is the power drawn by the load resistance (R_{L}) of the receiver. Fourth, the tuning of the receiver causes changes in reactance at the transmitter. Although four example factors are described here, other factors may also impact an impedance detected by the transmitter.

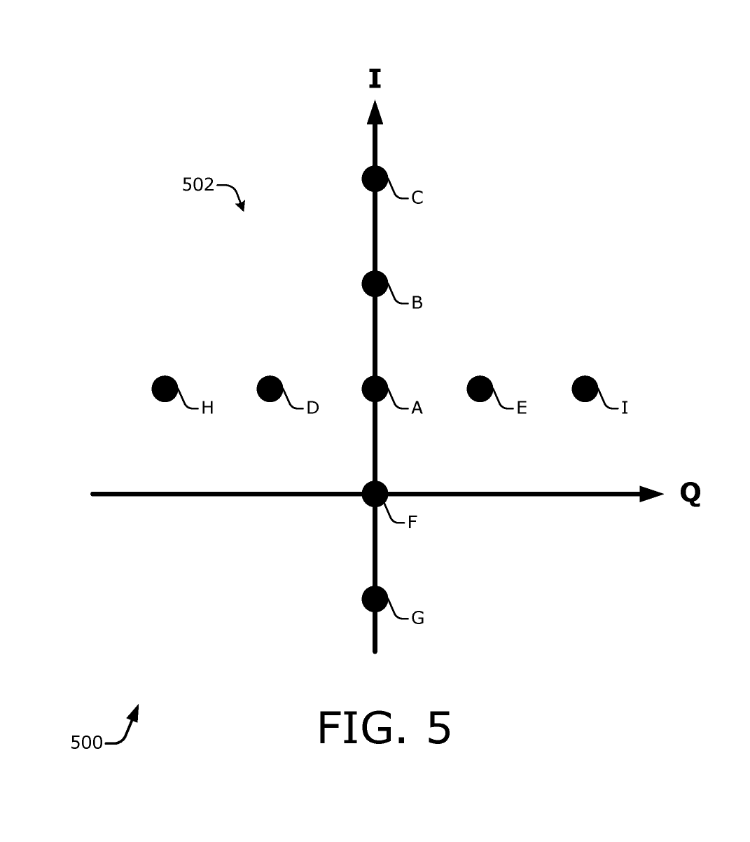

FIG. 5 depicts an example of a constellation 502 of impedance points that is achievable on a complex I-Q plane 500 using impedance-based modulation with two apparatuses that are inductively coupled. The complex I-Q plane 500 includes an in-phase axis (I) and a quadrature axis (Q). Thus, the I-axis pertains to the in-phase or real component of a signal, and the Q-axis pertains to the quadrature or imaginary component of the signal. The constellation 502 of impedance points includes nine points “A” through “I”.

A transmit coil, which is tuned to resonance, typically appears as the point “F.” At the point “F,” there is zero real impedance and zero reactance. In practice, however, there is a small positive real impedance due to the resistance of the transmit coil, but this real impedance is relatively close to zero. When a wireless power receiver is brought into proximity with a wireless power transmitter, the wireless charging device presents itself to the wireless charger device as some small real impedance, such as the point “A.” This real impedance represents the losses in the receive coil along with the quiescent current taken by the receiver. As the wireless power receiver draws more power, the impedance seen at the wireless power transmitter can increase along the I-axis to the point “B,” or even to the point “C.”

The points “D” and “E” represent situations in which the impedance signaling includes an imaginary component along one side or the other of the I-axis. In other words, the points “D” and “E” represent capacitive and reactive tuning cases in which the tuning of the receiver is off resonance and causes the impedance of the transmitter to drift away from the ideal tuning point, which is close to zero reactance. Specifically, the point “D” corresponds to a phase lag in which the tuning is below resonance, and the point “E” corresponds to a leading phase in which the tuning is above resonance. Thus, the point “H” corresponds to a larger phase lag that is even further below resonance, and the point “I” corresponds to an even greater leading phase with an above-resonance tuning.

The point “G” represents a different case as compared to the other illustrated points. At point “G,” the receiver is configured to drive power back out of the receiver coil and into the transmit coil. In effect, the wireless power receiver temporarily ceases being a passive device; instead, the wireless power receiver interjects power into the reverse link to contribute power to the signaling of the wireless power transmitter. For example, the wireless power receiver 304 (of FIG. 4) can drive the receiver inductor (L_{R}) with current to induce a voltage at the transmitter inductor (L_{T}) to generate a detectable impedance point usable for wireless communication in the reverse link. For this reason, those impedance points in a modulation constellation that are below the Q-axis are not practical to use at all times, if a purpose is to provide power to the wireless power receiver. However, those points with a negative real impedance can be used for signaling at certain times if a larger modulation constellation is desired. Example use cases for driving power out of the receiver are described herein below.

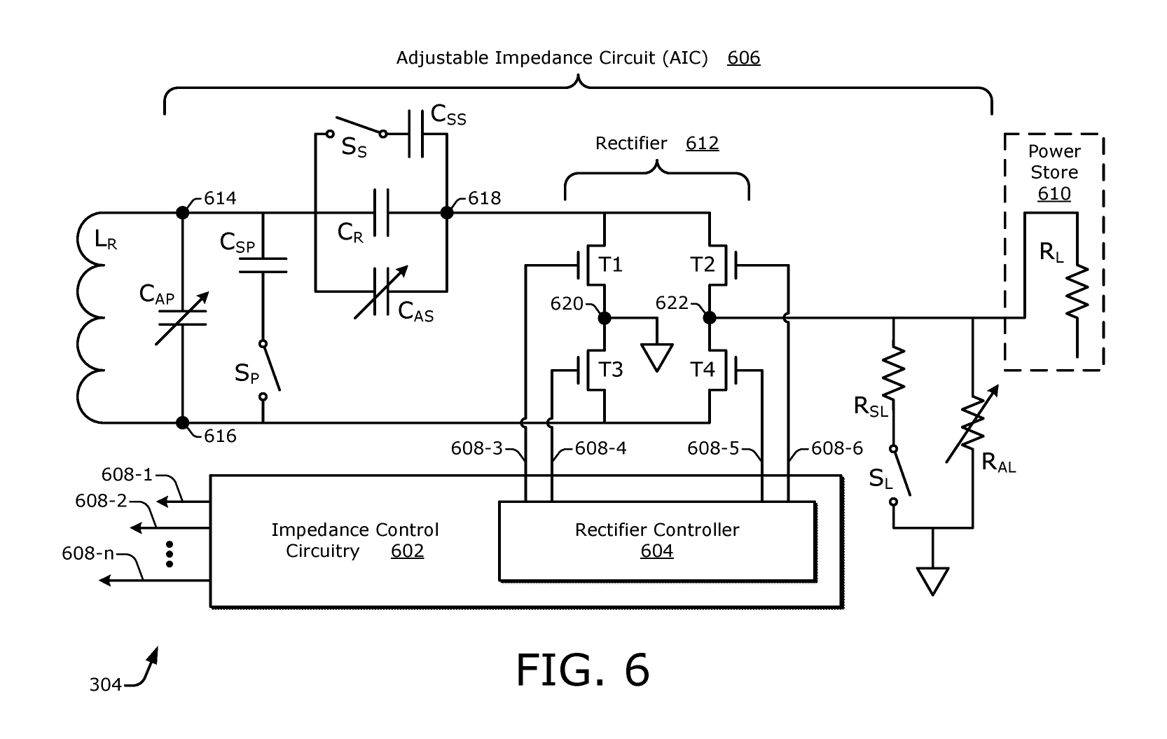

From the example impedance points “A” through “F” of the constellation 502, it is apparent that a wide variety of impedance points are available for modulation in a wireless power environment. Techniques for achieving impedance points that are located in each of the four quadrants of the complex I-Q plane 500 are described below, especially with reference to FIG. 6.

FIG. 6 illustrates an example of circuitry for a wireless power receiver 304. The wireless power receiver 304 includes a receiver inductor (L_{R}) on the left, as also shown in FIG. 4. The wireless power receiver 304 also includes a power store 610 on the right that is represented by a load resistance (R_{L}), an adjustable impedance circuit 606 (AIC) in the middle, and impedance control circuitry 602 in the lower half. As shown, the adjustable impedance circuit 606 includes multiple capacitors, a rectifier 612, and multiple resistances that are depicted as resistors. The multiple capacitors include a receiver capacitor (C_{R}), which is also shown in FIG. 4. The impedance control circuitry 602 includes a rectifier controller 604. The capacitors, the resistances, and the rectifier 612 can be adjusted to change an impedance of the wireless power receiver 304, which is detectable at the wireless power transmitter 302 (of FIGS. 3 and 4).

In example implementations, the receiver inductor (L_{R}) is coupled between a node 614 and a node 616. An adjustable parallel capacitor (C_{AP}) is also coupled between the node 614 and the node 616. A switched parallel capacitor (C_{SP}) and a parallel switch (Sp) are coupled in series with each other and in parallel with the receiver inductor (L_{R}) across the nodes 614 and 616. The receiver capacitor (C_{R}) is coupled between the node 614 and a node 618. An adjustable series capacitor (C_{AS}) is also coupled between the node 614 and the node 618. A switched series capacitor (C_{SS}) and a series switch (S_{S}) are coupled in series with each other and in parallel with the receiver capacitor (C_{R}) across the nodes 614 and 618. The receiver capacitor (C_{R}), the switched series capacitor (C_{SS}), and the adjustable series capacitor (C_{AS}) are thus coupled in series with the receiver inductor (L_{R}) at the node 614.

The rectifier 612 includes four transistors: a first transistor (T1), a second transistor (T2), a third transistor (T3), and a fourth transistor (T4). The transistors can be implemented with, for example, field effect transistors (FETs). The first transistor (T1) is coupled between the node 618 and a node 620. The third transistor (T3) is coupled between the node 620 and the node 616. The node 620 is coupled to an equipotential node, such as a ground node. The second transistor (T2) is coupled between the node 618 and a node 622. The fourth transistor (T4) is coupled between the node 622 and the node 616. Each respective transistor of the four transistors T1, T2, T3, and T4 is coupled to the rectifier controller 604 via a respective gate of one of the four transistors. Thus, the rectifier controller 604 can control whether each respective transistor is turned on or off by applying a voltage signal to the corresponding gate thereof.

An adjustable load resistance (R_{AL}) is coupled between the node 622 and the ground node. A switched load resistance (R_{SL}) and a load switch (S_{L}) are coupled in series with each other and in parallel with the load resistance (R_{L}) between the node 622 and the ground node. The load resistance (R_{L}) of the power store 610 is also coupled to the node 622. Examples of the power store 610 include a battery and a capacitor.

The impedance control circuitry 602 adjusts an impedance of the adjustable impedance circuit 606 to establish an impedance corresponding to a given impedance point of a selected modulation constellation, such as one of the impedance points shown in FIG. 5. In operation, the impedance control circuitry 602 generates multiple control signals 608-1, 608-2, 608-3 . . . 608-n, with “n” representing some integer. Each control signal 608 operates on a switch, an adjustable component, a transistor, some combination thereof, and so forth. For example, the impedance control circuitry 602 can set a switch, such as the parallel switch (S_{P}), to an open or closed position. Alternatively, the impedance control circuitry 602 can program a capacitance value or a resistance value of an adjustable component, such as the adjustable load resistance (R_{AL}). Further, the rectifier controller 604 can adjust the impedance of the adjustable impedance circuit 606 by varying the phase of one or more of the control signals 608-3, 608-4, 608-5, and 608-6 to one of the gates of the four transistors T1, T2, T3, and T4, respectively.

Thus, the impedance control circuitry 602 can adjust the impedance of the wireless power receiver 304 along the I-axis or along the Q-axis of the complex I-Q plane in either the positive or the negative direction. First, the real impedance can be changed in the positive direction by increasing the load resistance. For example, the impedance control circuitry 602 can switch in the switched load resistance (R_{R}) using the load switch (S_{L}) or can increase the resistance value of the adjustable load resistance (R_{AL}) to create different positive impedances along the I-axis.

Second, the impedance control circuitry 602 can make tuning changes in either direction. For example, to vary the shunt tuning, the capacitance value of the adjustable parallel capacitor (C_{AP}) can be varied, or the switched parallel capacitor (C_{SP}) can be switched in or out using the parallel switch (S_{P}). Alternatively, to vary the series tuning, the capacitance value of the adjustable series capacitor (C_{AS}) can be varied, or the switched series capacitor (C_{SS}) can be switched in or out using the series switch (S_{S}). Any of these capacitive changes, independently or together, cause a change in the reflected complex impedance along the Q-axis as seen by the transmitter.

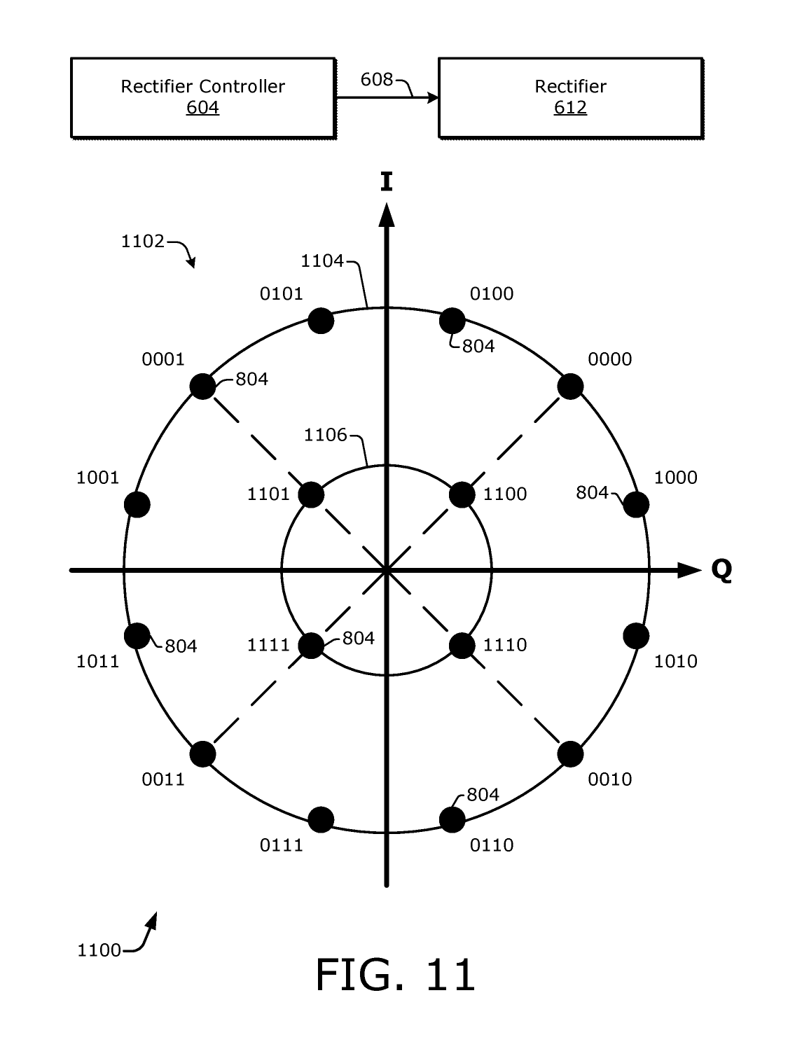

Third, the rectifier controller 604 can make phase changes using the rectifier 612 to produce reactive changes. By changing (e.g., advancing or retarding) the phase of a synchronous rectifier, the apparent impedance of the rectifier can be made more capacitive or vice versa. For example, the rectifier controller 604 can use the control signals 608-3 through 608-6 to close the transistor switches slightly before a zero cross location to change the signaling phase. Fourth, the rectifier controller 604 can implement rectifier phase changes to produce real changes in the impedance. To change the real impedance with the rectifier 612, a synchronous rectifier can be reversed, which results in the apparent real impedance being negative along the I-axis. For instance, the rectifier controller 604 can use the rectifier 612 like an H-bridge to transmit power from the wireless power receiver 304. Adjusting operational timings of the rectifier 612 to produce reactive or real impedance changes is described below with reference to FIG. 11.

The different components of the adjustable impedance circuit 606 can also be used individually or jointly in any combination to achieve a given impedance point, such as one of the example impedance points “A” through “I” of the constellation 502 (of FIG. 5). For example, as a wireless power receiver 304 is placed proximate to a wireless power transmitter 302, the impedance point “B” can be created based on the adjustable load resistance (R_{AL}). If the resistance of the adjustable load resistance (R_{AL}) of the wireless power receiver 304 is increased, the impedance generated in the wireless power transmitter 302 can increase to the impedance point “C.” To reduce the impedance detected at the wireless power transmitter 302 to the point “A,” the wireless power receiver 304 can switch into the circuit the switched load resistance (R_{SL}). As another example, the wireless power receiver 304 can generate the impedance point “E” at the wireless power transmitter 302 by switching into the circuit the switched series capacitor (C_{SS}). However, to reach a further reactive point along the Q-axis, such as the impedance point “I,” the wireless power receiver 304 also activates the rectifier 612 to further increase the leading phase by changing the signal timing. Other components can be selectively activated (e.g., by changing an adjustable value or by switching a component into the circuit) individually or in any combination to realize various impedance points across a given modulation constellation.

Multiple different example components are illustrated in FIG. 6 as being part of the adjustable impedance circuit 606. These components include capacitances coupled in parallel with the receiver inductor (L_{R}), capacitances coupled in series with the receiver inductor (L_{R}), different load resistances, a rectifier coupled across the receiver inductor (L_{R}), and so forth. However, different combinations or sub-combinations of these components may be implemented in a wireless power receiver 304. In other words, all the components that are depicted in FIG. 6 or described herein do not need to be included in a given implementation. For example, the adjustable parallel capacitor (C_{AP}) and the switched series capacitor (C_{SS}) can be excluded from the adjustable impedance circuit 606, while the switched parallel capacitor (C_{SP}) and the adjustable series capacitor (C_{AS}) are included.

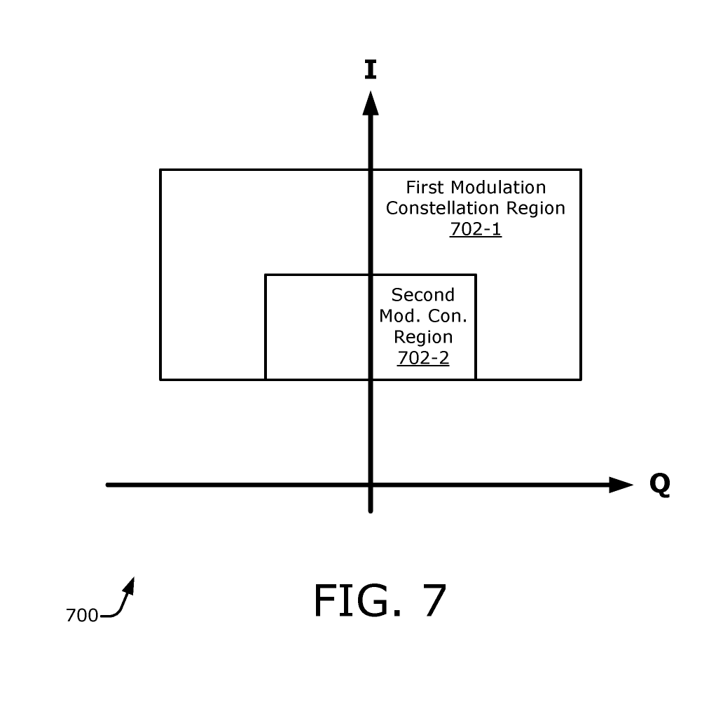

FIG. 7 depicts examples of different sizes of modulation constellations on a complex I-Q plane 700. Modulation constellations can cover different areas of the complex I-Q plane 700. Two examples are shown: a larger, first modulation constellation region 702-1 and a smaller, second modulation constellation region 702-2. Generally, more impedance points (and thus higher throughputs) are achievable with a larger modulation constellation region as compared to a smaller modulation constellation region. Thus, a modulation constellation for the first modulation constellation region 702-1 can have more impedance points than the second modulation constellation region 702-2.

As the inductive coupling quality 310 (of FIG. 3) increases between a wireless power transmitter and a wireless power receiver, the size of a potential modulation constellation region likewise increases. Thus, as the inductive coupling quality 310 increases, the number of achievable impedance points is also likely to increase. This can be expressed qualitatively: If there is zero coupling between the transmitter and receiver, then nothing the receiver does will be seen by the transmitter, and no modulation is possible. If a coupling level is relatively small (e.g., a coupling constant (K) with a value less than approximately 0.1), then the receiver cannot make a large change in the transmitter's impedance. This situation is represented by the second modulation constellation region 702-2 on the complex I-Q plane 700. However, if the coupling level is relatively large (e.g., a coupling constant (K) with a value greater than approximately 0.5), then the receiver can make a relatively large change in the impedance as detected at the transmitter. This situation is represented by the first modulation constellation region 702-1. Thus, the case with the relatively higher coupling level enables the wireless power receiver to communicate a relatively larger constellation of impedance points back to the wireless power transmitter.

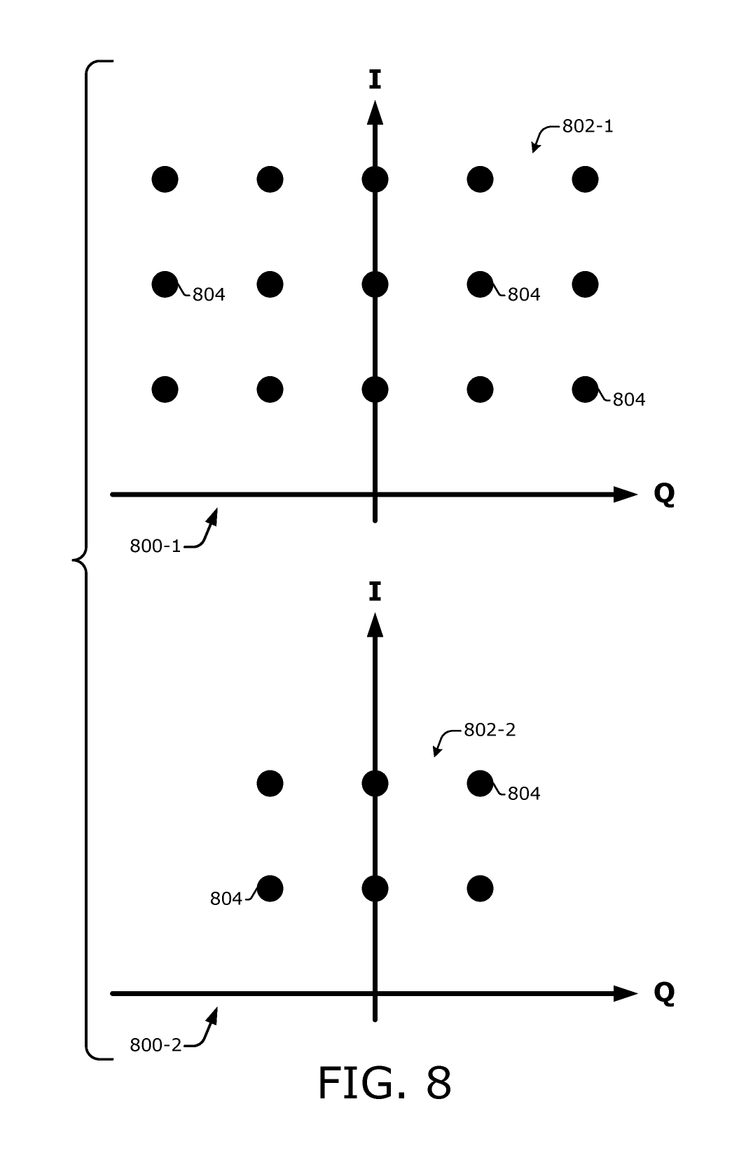

FIG. 8 depicts examples of different modulation constellations on complex I-Q planes 800-1 and 800-2. At a first complex I-Q plane 800-1, a first modulation constellation 802-1 corresponds to the first modulation constellation region 702-1 of FIG. 7. At a second complex I-Q plane 800-2, a second modulation constellation 802-2 corresponds to the second modulation constellation region 702-2. In the illustrated example, the first modulation constellation 802-1 includes fifteen (15) impedance points 804, a few of which are explicitly referenced. The second modulation constellation 802-2 includes six (6) impedance points 804.

Generally, a given impedance point is distinguishable from other impedance points if the given impedance point is sufficiently distant so as to ensure that noise does not make distinguishing the given impedance point from the other impedance points too difficult to some specified level of reliability. Consequently, the relatively low coupling quality case, which corresponds to the second modulation constellation region 702-2 and the second modulation constellation 802-2, may give rise to a relatively smaller constellation of impedance points 804. As shown at the second complex I-Q plane 800-2, there are six (6) impedance points 804. Conversely, the relatively high coupling quality case, which corresponds to the first modulation constellation region 702-1 and the first modulation constellation 802-1, may give rise to a relatively larger constellation of impedance points 804. As shown at the first complex I-Q plane 800-1, there are fifteen (15) impedance points 804. In this example, the greater coupling situation allows for a modulation constellation that is 2.5 times larger, which enables a 2.5 times increase in the data rate given the same symbol rate.

Thus, from one perspective, modulation constellations can be characterized in terms of size. As the range of impedances across a complex I-Q plane increases, a size of a corresponding modulation constellation can also increase. Similarly, as a number of available impedance points increases, a size of a corresponding modulation constellation can likewise increase. These two size aspects can also increase together. In other words, at a given density of impedance points, as the range of impedances across a complex I-Q plane increases, the available number of impedance points increases. Generally, a modulation constellation can be diminished to increase a likelihood that symbols reflected by a wireless power receiver 304 are correctly detected by a wireless power transmitter 302 under a given inductive coupling quality 310. To diminish a modulation constellation in terms of size, modulation control circuitry can reduce a region over the complex I-Q plane from which impedance points can be generated (as shown in FIG. 7) or can reduce a number of impedance points that can be associated with a symbol to be transmitted (as shown in FIG. 8). Diminishing a modulation constellation tends to make communicating a symbol less arduous or more successful. As another example of diminishing a modulation constellation, a density of impedance points can be decreased by increasing a separation distance between adjacent impedance points across a complex I-Q plane. This increased separation distance typically renders detection and identification of an intended impedance point easier.

As described above, a wireless power receiver 304 can reflect a backscatter signal 108 to a wireless power transmitter 302 with the information encoded via impedance shift points. More specifically, an impedance value at the receiver can be detected at the transmitter to create a reverse link for communications from the receiver to the transmitter. By establishing different impedance values at the receiver in accordance with some modulation scheme 118, multiple impedance points 804 can be instantiated as a modulation constellation 802. Further, a modulation constellation 802 of multiple impedance points 804 can be adapted to change a level of throughput that is possible in a given backscatter communications system. Example systems that can determine a modulation scheme 118, including a modulation constellation size, that is appropriate for the current conditions of a backscatter communications system are described below.

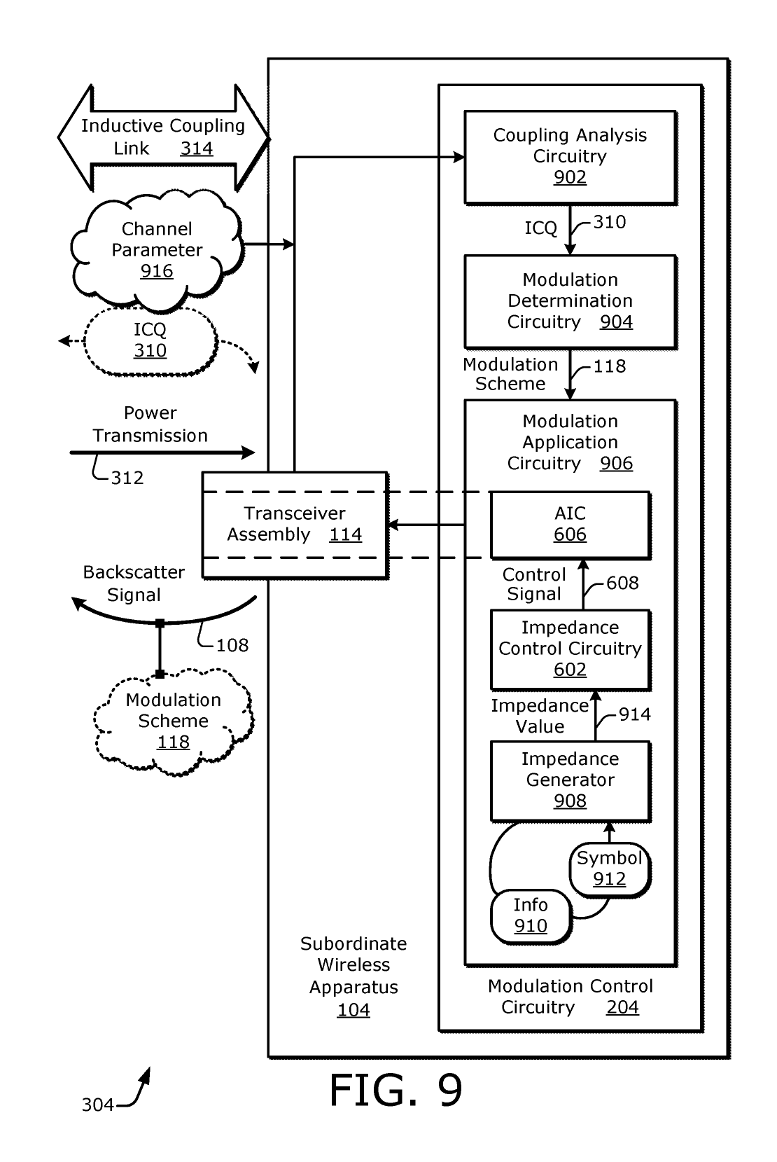

FIG. 9 illustrates an example of modulation control circuitry 204 in conjunction with a transceiver assembly 114 for a subordinate wireless apparatus 104. As shown, the modulation control circuitry 204 includes coupling analysis circuitry 902, modulation determination circuitry 904, and modulation application circuitry 906. The modulation application circuitry 906 includes the adjustable impedance circuit 606, the impedance control circuitry 602, and an impedance generator 908. The coupling analysis circuitry 902 and the modulation application circuitry 906 are coupled to the transceiver assembly 114. FIG. 9 also depicts the power transmission 312 and the backscatter signal 108, which is modulated in accordance with a modulation scheme 118.

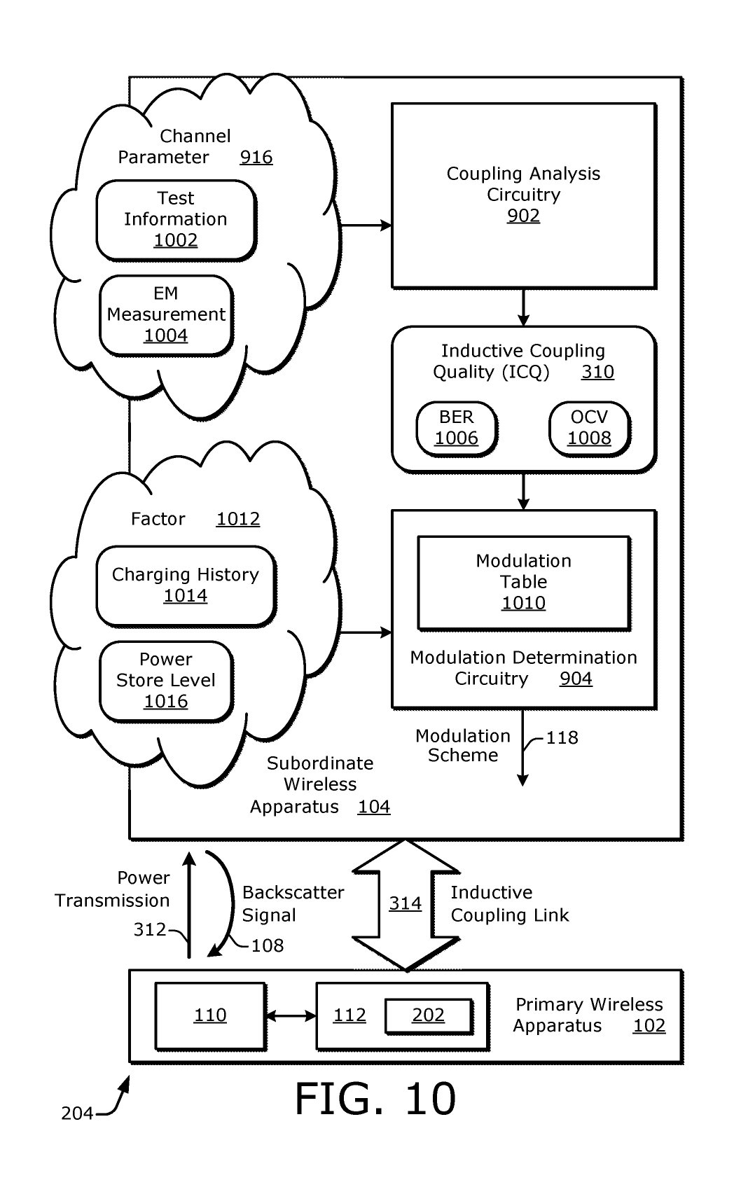

In example implementations, the coupling analysis circuitry 902 determines an inductive coupling quality 310 based on the inductive coupling link 314 extending between the primary wireless apparatus 102 and the subordinate wireless apparatus 104. The coupling analysis circuitry 902 can further determine the inductive coupling quality 310 based on at least one channel parameter 916, which can be obtained via the transceiver assembly 114 as an indicator of the inductive coupling quality 310. The channel parameter 916 is described further with reference to FIG. 10. The coupling analysis circuitry 902 provides the inductive coupling quality 310 to the modulation determination circuitry 904. The modulation determination circuitry 904 determines a modulation scheme 118 based on the inductive coupling quality 310. Example techniques for implementing the coupling analysis circuitry 902 and the modulation determination circuitry 904 are described below with reference to FIG. 10. The modulation determination circuitry 904 provides the determined modulation scheme 118 to the modulation application circuitry 906.

In addition to the determined modulation scheme 118, the modulation application circuitry 906 has access to information 910 that is to be communicated via the backscatter signal 108. The impedance generator 908 encodes the information 910 into a symbol 912 based on the determined modulation scheme 118. The symbol 912 corresponds to an impedance point 804 of a modulation constellation 802 for the determined modulation scheme 118. Thus, the impedance generator 908 converts the symbol 912 into an impedance value 914 of the corresponding impedance point 804. The impedance generator 908 provides the impedance value 914 to the impedance control circuitry 602.

The impedance control circuitry 602 therefore receives the generated impedance value 914 from the impedance generator 908. Based on the generated impedance value 914, the impedance control circuitry 602 generates at least one control signal 608 to establish the impedance value 914 using the adjustable impedance circuit 606. In response to receiving multiple control signals 608-1 through 608-n, the adjustable impedance circuit 606 flips switches, adjusts components, changes timings of a rectifier, and so forth to establish the impedance value 914, as is described above with reference to FIG. 6. The adjustable impedance circuit 606 can be coupled to, or at least partially incorporated as part of, the transceiver assembly 114 as indicated by the dashed lines connecting the two rectangles. Changes to the impedance established by the adjustable impedance circuit 606 therefore affect the impedance of the transceiver assembly 114, which can be detected by the primary wireless apparatus 102 via the backscatter signal 108.

In some implementations, circuitry can be realized using a processing unit and processor-executable instructions that are stored on non-transitory processor-accessible media. Examples of a processing unit include a general-purpose processor, an application specific integrated circuit (ASIC), a microprocessor, a digital signal processor (DSP), hard-coded discrete logic, or a combination thereof. The processor-accessible media can include memory to retain the processor-executable instructions for software, firmware, hardware modules, and so forth. Memory may be volatile or nonvolatile memory, such as random access memory (RAM), read-only memory (ROM), flash memory, static RAM (SRAM), or a combination thereof. Additionally or alternatively, the circuitry can be realized using analog circuitry, such as resistors and comparators; digital circuitry, such as transistors and flip-flops; combinations thereof and so forth. The processor-executable instructions, or other forms of circuitry, can be implemented in accordance with the techniques and algorithms described herein. Although illustrated separately, the coupling analysis circuitry 902, the modulation determination circuitry 904, or the modulation application security 906 can alternatively be combined or integrated together at the coding stage, at the compiling stage, at the architectural or design stage, at the synthesis stage, and so forth.

FIG. 10 illustrates an example of the coupling analysis circuitry 902 and the modulation determination circuitry 904 of the modulation control circuitry 204, which is depicted in FIG. 9 as part of the subordinate wireless apparatus 104. In some example implementations, a channel parameter 916 includes test information 1002, and a corresponding inductive coupling quality 310 includes a bit error rate 1006 (BER). In other example implementations, a channel parameter 916 includes an electromagnetic measurement 1004, and a corresponding inductive coupling quality 310 includes an open circuit voltage 1008 (OCV). With either approach, the modulation determination circuitry 904 can include a modulation table 1010 that associates an inductive coupling quality 310 with a modulation scheme 118 or provides a ranking of modulation schemes by potential bandwidth. The test information approach is described next, and the EM measurement approach is described thereafter.

For the test information approach, a trial with one or more modulation schemes is performed in conjunction with a closed-loop feedback mechanism to determine communication error. In a typical backscatter communications system, the forward link is robust as compared to the reverse link. In other words, the forward link typically has a significantly higher signal-to-noise ratio (SNR). The forward link can therefore be used to check or verify if information placed on the reverse link is being correctly received. Initially, a large modulation constellation can be attempted with a high bandwidth and strong error detection as part of the trial. If the communication is received without error, the large modulation constellation is used. If, on the other hand, a high error rate is detected, a smaller modulation constellation is attempted to continue the trial. The size of the modulation constellation is then decreased until the detected error is acceptable. A determination of whether an error is acceptable can be based on an error threshold, such as a maximum number of errors per unit of time or data. For example, a detected error rate can be deemed acceptable if the detected error rate comports with an error rate threshold.

Thus, the test information 1002 relates to communication error and can take many forms depending on what testing mechanism is being implemented and whether the test information 1002 is placed on the forward link or the reverse link. For example, the test information 1002 can include: a communication having data as well as an accompanying error detection component, such as an error-correcting code (ECC) or a forward error correction (FEC) code; information that is to be compared to known information for verification purposes; an indication of an accuracy level of information that has already been received and verified; an implicit or explicit error indication, such as an error rate for information that has already been communicated across the wireless channel; some combination thereof; and so forth. In operation, the coupling analysis circuitry 902 uses the test information 1002 to produce the bit error rate 1006. The bit error rate 1006 can include a numeric error per unit of time or data; a categorical indicator such as low, medium, or high; a Boolean indicator such as acceptable or not acceptable; some combination thereof; and so forth. The bit error rate 1006 can therefore reflect a quality of the inductive coupling link 314.

The modulation determination circuitry 904 uses the bit error rate 1006 and the modulation table 1010 to determine the modulation scheme 118. If the bit error rate 1006 is too high, the modulation determination circuitry 904 moves up the modulation table 1010 to a modulation scheme 118 having a smaller modulation constellation. If the bit error rate 1006 is sufficiently low, the modulation determination circuitry 904 can maintain a current modulation scheme 118 or can move down the modulation table 1010 to a larger modulation constellation. A modulation constellation is relatively smaller if, for instance, the modulation constellation has fewer total impedance points or if the impedance points are spaced farther apart—e.g., if the impedance points are less dense or more sparse. Conversely, a modulation constellation is relatively larger if the modulation constellation has more total impedance points or if the impedance points are spaced closer together—e.g., if the impedance points are more dense.

With the test information approach, the subordinate wireless apparatus 104 can interact with the primary wireless apparatus 102. In such implementations, the transceiver assembly 110 of the primary wireless apparatus 102 generates the power transmission 312. The transceiver assembly 110 also receives the backscatter signal 108, which is reflected from the subordinate wireless apparatus 104 using the power transmission 312 via the inductive coupling link 314. The backscatter signal 108 carries information 910 (of FIG. 9) based on a determined modulation scheme 118. The transceiver controller 112 analyzes the backscatter signal 108 to produce detected impedances that respectively correspond to impedance points 804 in accordance with the current modulation scheme 118. The transceiver controller 112 also processes the impedance points 804 based on the current modulation scheme 118 to recover the information 910. The modulation control circuitry 202 computes an error indication based on the information 910 that is recovered by the transceiver controller 112.

Error indications can be computed based on a comparison of received information versus expected information, on an error identification code that is received as part of the recovered information 910, some combination thereof, and so forth. The transceiver controller 112 further causes the transceiver assembly 110 to generate another power transmission 312, which includes the computed error indication. A transmitted error indication can be included as part of, for instance, test information 1002. The modulation control circuitry 202 further causes the transceiver controller 112 to change to a different modulation scheme 118 to enable other impedance points 804 from another backscatter signal 108 to be processed in accordance with a newly-determined modulation scheme 118.

For the EM measurement approach, an electrical or magnetic measurement is taken in the transceiver assembly 114 (e.g., of FIGS. 6 and 9). The coupling analysis circuitry 902 determines the inductive coupling quality 310 based on the EM measurement 1004. The EM measurement 1004 can reflect a quality of the inductive coupling link 314. For example, with reference also to FIG. 4, the coupling constant (K) can be determined directly or indirectly. The coupling constant (K) can be derived from the mutual inductance (M) using the following formula: K=M/sqrt(L1*L2), where “L1” and “L2” are the inductances of the transmit and receive coils. These can be measured by looking at the open circuit voltage (OCV) at the wireless power receiver given a fixed current at the wireless power transmitter. Thus, if the current is fixed, the open circuit voltage is directly dependent on K or M.

In these implementations, the modulation table 1010 can associate an open circuit voltage 1008 (OCV) to a corresponding modulation constellation to determine the modulation scheme 118. The Table 1 below provides an example. A measured open circuit voltage (OCV) at a fixed transmit current is used to look up the corresponding modulation constellation. As shown below, different measured voltages correspond to both an inferred mutual inductance (M) (in nanohenries (nH)) and an appropriate modulation constellation to use for the modulation scheme 118. Each of the modulation constellations is expressed in terms of a constellation of impedance points across the complex I-Q plane. The included voltages, nanohenries, and constellations are provided as examples.

TABLE 1
Measured open circuit voltage (OCV)
linked to modulation constellation.

| | | Modulation |
|---|---|---|
| Measured OCV | Assumed M | Constellation |
| 6 V | 100 nH | 3 × 5 j |
| 7 V | 117 nH | 4 × 6 j |
| 8 V | 133 nH | 4 × 7 j |
| 9 V | 150 nH | 5 × 8 j |

The test information and EM measurement implementations can be combined by the modulation control circuitry 204. To do so, the modulation determination circuitry 904 can determine an initial modulation constellation for the modulation scheme 118 using the open circuit voltage 1008 (OCV) in accordance with a table like Table 1. If the initial modulation constellation is too error prone or becomes too error prone over time, as ascertained by the coupling analysis circuitry 902 based on the test information 1002 or the corresponding bit error rate 1006, the modulation determination circuitry 904 can drop down to a smaller modulation constellation for a different modulation scheme 118.

At least one other factor 1012 can be considered as part of the determination of the modulation scheme 118. For example, whether a negative real impedance point is to be used can be based on a factor 1012. As described above, using an impedance point with a negative real impedance involves relying on a power store (e.g., a batter or a capacitor) to “back drive” the system for those impedance points that are below the Q-axis. Although this allows for a larger modulation constellation, there is a cost in power usage. The subordinate wireless apparatus 104 should therefore generally have sufficient energy accumulated in the power store before using such signaling.

Factors 1012 that pertain to energy accumulation include a charging history 1014, a power store level 1016, and so forth. Thus, the modulation determination circuitry 904 can determine the modulation scheme 118 based on the power store level 1016 (e.g., a charge level of a power store), the charging history 1014, a power store level threshold or a charge level threshold, some combination thereof, and so forth. For example, the modulation determination circuitry 904 can prevent usage of a modulation scheme 118 that consumes power of the power store 610 unless the power store level 1016 meets a charge level threshold. As another example, the modulation determination circuitry 904 can employ a rule such as “exclude negative real impedance signaling if the battery is below 10%” or “exclude negative real impedance signaling if an accumulator capacitor is below 8 volts.” More advanced techniques can be based on the charging history 1014 of the wireless power receiver. For instance, a likelihood that a charging device will have ample opportunity to receive a full charge prior to being disengaged from a wireless charger device can be calculated based on a time of day, a location of the charging, combinations thereof, and so forth. The modulation determination circuitry 904 can therefore employ a rule such as “permit negative real impedance signaling if the device is expected to be charging for a sufficient period of time such that a full charge can be reached even if power is used for impedance signaling.”

FIG. 11 illustrates a rectifier controller 604 and a rectifier 612, which can be part of the adjustable impedance circuit 606 (of FIGS. 6 and 9). FIG. 11 also depicts an example of a 4-12 amplitude and phase-shift keying (APSK) modulation constellation 1102 on a complex I-Q plane 1100. The APSK modulation constellation 1102 can be implemented using the rectifier 612 responsive to at least one control signal 608 provided by the rectifier controller 604. The rectifier 612 can be used to establish different impedance points for a modulation constellation of a modulation scheme. The rectifier controller 604 creates phase shifts by activating switches (e.g., transistors) slightly late or slightly early, as is explained below.

A synchronous rectifier, such as a full bridge or voltage doubler, can create a modulation constellation. Two example modulation types for synchronous rectifiers are: quadrature phase shift keying (QPSK) and APSK. A voltage doubler rectifier is more suitable for constellations with impedance points that fall on a single circle. In contrast, a bridge rectifier or multilevel rectifier can produce impedance points that fall on multiple concentric circles of a modulation constellation, such as with the 4-12 APSK modulation constellation 1102.

Using a rectifier to implement QPSK modulation is described first. There are four impedance points with QPSK. Two of the points in the constellation generate power at the wireless power receiver. For the other two points, however, the receiver provides in-band energy. The four points on the constellation can be generated by adjusting the phase of the rectifier 612 with respect to the phase of the transmitter. When the rectifier phase is less than +/−90 degrees from the transmitter phase, power can still be received by the receiver. Due to practical efficiency limitations, however, the range of the rectifier phase is likely more limited in order to ensure an adequate level of power reception. Thus, two of the four impedance points of the modulation constellation can be located approximately +/−45 degrees from the transmitter phase, which enables a more efficient reception of power. Further, information can be encoded such that the two impedance points of the QPSK modulation constellation that entail a power draw from the receiver occur less frequently. This approach to encoding results in less than two bits of information per symbol, yet the approach still provides more than the one bit of information per symbol that would result from relying solely on the two positive impedance points of a QPSK constellation.

As shown by the 4-12 APSK modulation constellation 1102, up to sixteen impedance points can be established using a bridge rectifier with 4-12 APSK modulation. Each quadrant has four impedance points 804, a few of which are individually indicated by reference number. Each impedance point 804 is also depicted with a four-bit binary value (e.g., “0100” and “1101”) for each corresponding symbol. Twelve of the impedance points 804 are located around an outer ring 1104, and four of the impedance points 804 are located around an inner ring 1106. The eight impedance points 804 that are located below the Q-axis correspond to impedance points at which the wireless power receiver drives power to signal with those impedance points. Although sixteen (16) total impedance points 804 are available with the 4-12 ASPK modulation constellation 1102, those impedance points that are closer to the I-axis, such as the “0101” point and the “0100” point, enable more power to be received. Thus, a determined modulation scheme 118 can focus on encoding information using such points to increase the rate of average power reception.

A synchronous bridge rectifier, for example, has three possible differential voltage states. These three voltage states are: positive, negative, and zero. The zero state is achieved by driving both ends of the synchronous bridge rectifier to the same voltage level. However, when receiving power, the positive and negative states are typically used. The synchronous bridge rectifier can signal like a doubler rectifier by switching between two of the possible states and then further modulate the impedance by controlling the phase of the switching. By switching the rectifier to the zero state instead of the positive or negative state, the impedance points 804 of the inner ring 1106 can also be created. As described above, the impedance points 804 below the Q-axis on both rings of the modulation constellation consume power because such impedance points are more than 90 degrees from the transmitted power.

As another example, note that eight phase-shift keying (8-PSK) modulation can be implemented by a voltage doubler rectifier. Moreover, any arbitrary number of impedance points on a circle can be produced with a voltage doubler rectifier by adjusting the phase. However, a better SNR is achieved with a smaller number of impedance points. Also, impedance points that are closer to the transmitter phase generate more power or require less power to employ while modulating a backscatter signal with impedance point shifting. Even though using some impedance points consumes power at the receiver, the data encoding scheme employed with 8-PSK can ensure that the net power received is positive.

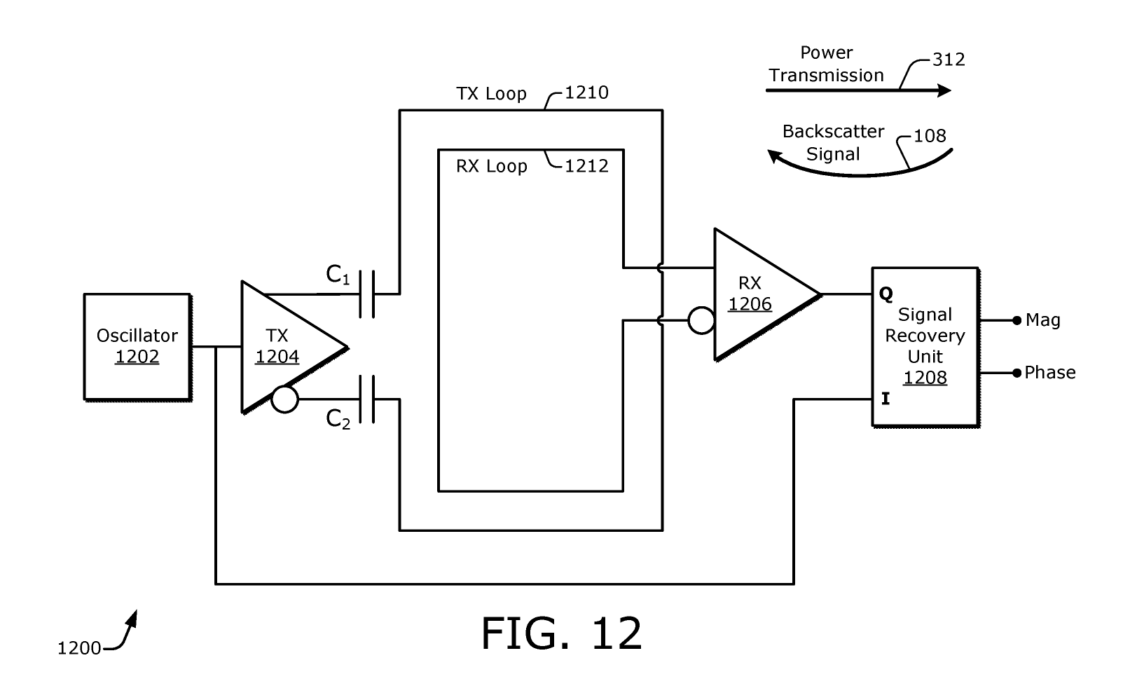

FIG. 12 illustrates an example alternative approach 1200 to detecting a reflected backscatter signal 108. The approaches described above pertain to measuring impedance “looking into” the transmit coil. In contrast, the approach 1200 uses a separate sense loop for the wireless power transmitter, with the phase reference coming from the original transmission signal. However, this approach 1200 may increase the SNR significantly because the fundamental transmission frequency is, from one perspective, merely “noise.” In other words, the fundamental transmission frequency is not intended to convey any particular information, other than serving as a reference frequency.

As shown, the circuitry for the approach 1200 includes an oscillator 1202, a transmitter 1204 (TX), a receiver 1206 (RX), and a signal recovery unit 1208. The circuitry further includes a first capacitor (C₁), a second capacitor (C₂), a transmit loop 1210, and a receive loop 1212. The oscillator 1202 provides a signal to an input of the transmitter 1204 and to an in-phase input (I) of the signal recovery unit 1208. The transmit loop 1210 is coupled to an output and an inverting output of the transmitter 1204 via the first capacitor (C₁) and the second capacitor (C₂), respectively. The receive loop 1212 is coupled to an input and an inverting input of the receiver 1206. An output of the receiver 1206 is coupled to a quadrature input (Q) of the signal recovery unit 1208.

In operation, the transmit loop 1210 generates a transmitted signal, which is realized as a power transmission 312 here, via the oscillator 1202 and the transceiver 1204. The receive loop 1212 receives the backscatter signal 108 as reflected responsive to the power transmission 312 using an inductive coupling link 314 (of FIG. 3). Thus, the signal recovery unit 1208 can obtain a phase reference from the oscillator 1202 via the in-phase input (I). The receiver 1206 obtains the backscatter signal 108 via the receive loop 1212. The receiver 1206 provides the obtained backscatter signal 108 to the signal recovery unit 1208 via the quadrature input (Q). Using the phase reference from the oscillator 1202 and the backscatter signal 108 from the receiver 1206, the signal recovery unit 1208 recovers the magnitude and phase of the signal being “sent” from the wireless power receiver to the wireless power transmitter over the reverse link.

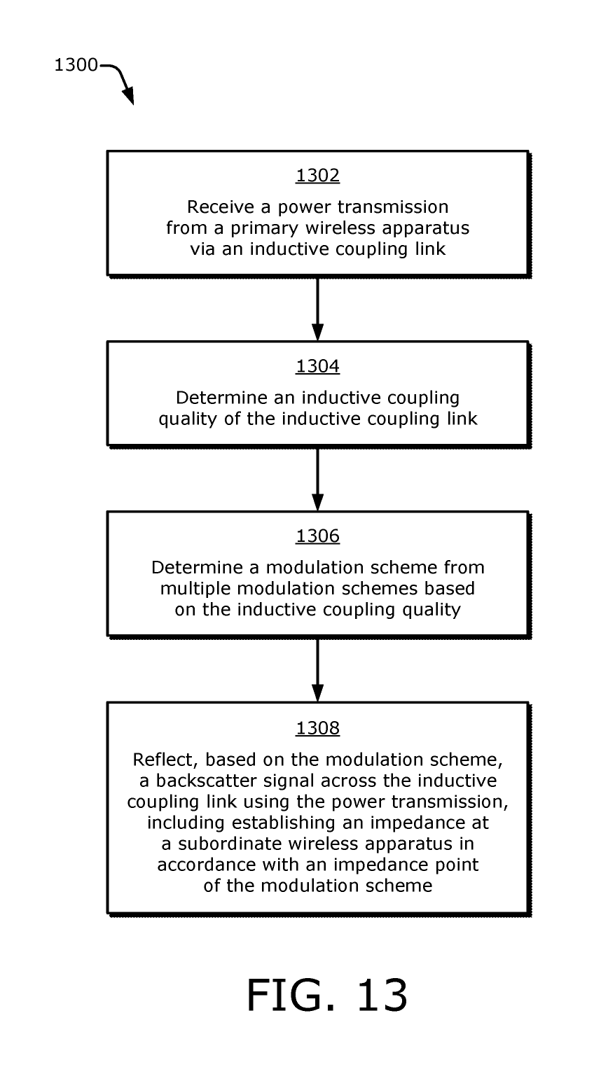

FIG. 13 is a flow diagram illustrating an example process 1300 for adapting a modulation scheme for backscatter signaling. The process 1300 is described in the form of a set of blocks 1302-1308 that specify operations that can be performed. However, operations are not necessarily limited to the order shown in FIG. 13 or described herein, for the operations may be implemented in alternative orders or in fully or partially overlapping manners. Operations represented by the illustrated blocks of the process 1300 can be performed by a subordinate wireless apparatus 104 (e.g., of FIG. 1 or 2) or a wireless power receiver 304 (e.g., of FIG. 3). More specifically, the operations of the process 1300 may be performed by modulation control circuitry 204 as shown in FIG. 9.

At block 1302, a power transmission is received from a primary wireless apparatus via an inductive coupling link. For example, a subordinate wireless apparatus 104 can receive a power transmission 312 from a primary wireless apparatus 102 via an inductive coupling link 314. The inductive coupling link 314 may extend, for instance, across the near-field using a magnetic field between the primary wireless apparatus 102 and the subordinate wireless apparatus 104.

At block 1304, an inductive coupling quality of the inductive coupling link is determined. For example, the subordinate wireless apparatus 104 can determine an inductive coupling quality 310 of the inductive coupling link 314. The inductive coupling quality 310, which is associated with the inductive coupling link 314 that extends between the two apparatuses, may be determined based on an error indication, such as a bit error rate 1006 derived from test information 1002. Additionally or alternatively, with a magnetic near-field coupling between the two apparatuses, the inductive coupling quality 310 may be determined using an electromagnetic measurement 1004, such as an open circuit voltage 1008, taken at a transceiver assembly 114 of the subordinate wireless apparatus 104.

At block 1306, a modulation scheme is determined from multiple modulation schemes based on the inductive coupling quality. For example, the subordinate wireless apparatus 104 can determine a modulation scheme 118 from multiple modulation schemes 118-1 through 118-n based on the inductive coupling quality 310. For instance, a modulation table 1010 may rank the multiple modulation schemes 118-1 through 118-n in order of potential bandwidth or in order of robustness against a poor inductive coupling quality 310. Also, the modulation table 1010 may respectively associate different inductive coupling qualities, such as different mutual inductances, with different modulation schemes that are likely to be effective for a given mutual inductance that is present between the two apparatuses. Each modulation scheme 118 may include a modulation constellation having multiple impedance points 804 that are specified over a complex plane, as well as incorporating a rule that affects modulation based on at least one factor 1012.

At block 1308, a backscatter signal is reflected, based on the modulation scheme, across the inductive coupling link using the power transmission, including by establishing an impedance at the subordinate wireless apparatus in accordance with an impedance point of the modulation scheme. For example, the subordinate wireless apparatus 104 can reflect, based on the determined modulation scheme 118, a backscatter signal 108 across the inductive coupling link 314 using the power transmission 312. To do so, the subordinate wireless apparatus 104 may establish different impedances at the transceiver assembly 114 based on information 910 and in accordance with impedance points 804 of the determined modulation scheme 118. Due to the inductive coupling link 314, the information 910 is reflected back to the primary wireless apparatus 102 responsive to the power transmission 312 via at least one magnetic field extending between the two apparatuses.

Thus, example implementations of the process 1300 can involve inductive coupling scenarios. For example, the primary wireless apparatus 102 can be inductively coupled to the subordinate wireless apparatus 104 via an inductive coupling link 314. In such a situation, an inductive coupling quality 310 can be dependent on an inductive coupling constant (K) between the primary wireless apparatus 102 and the subordinate wireless apparatus 104. Consequently, an implementation of the determination of the modulation scheme at block 1306 can include determining the modulation scheme 118 based on the inductive coupling constant (K). Further, the inductive coupling constant (K) may be dependent on a mutual inductance (M) between the primary wireless apparatus 102 and the subordinate wireless apparatus 104. Thus, the inductive coupling quality 310 can be based on an estimate of the inductive coupling constant (K) or the mutual inductance (M) using at least one electromagnetic value measured at the subordinate wireless apparatus 104. Using an electromagnetic measurement 1004, an implementation of the determination of the modulation scheme based on the inductive coupling constant (K) can include determining the modulation scheme 118 based on the mutual inductance (M).

Instead of relying on the inductive coupling constant (K) or to refine an initial modulation scheme that was determined using the inductive coupling constant (K), an indication of communication error can be used for the determination. For example, an implementation of the determination of the inductive coupling quality 310 at block 1304 can include determining the inductive coupling quality 310 based on test information 1002 that is related to a communication error that occurs with the backscatter signal 108 being reflected from the subordinate wireless apparatus 104 to the primary wireless apparatus 102.

Implementations of the process 1300 can also involve certain modulation scheme scenarios. For example, the modulation scheme 118 can include a modulation constellation 802 having multiple impedance points 804, with each impedance point 804 corresponding to a location on an in-phase/quadrature (I-Q) plane. In such situations, the reflection of the backscatter signal at block 1308 can include reflecting the backscatter signal 108 responsive to the power transmission 312 and using at least a portion of the multiple impedance points 804. Further, the determination of the modulation scheme at block 1306 may include switching to a different modulation scheme 118 by reducing a number of impedance points 804 for the different modulation scheme 118 or by reducing a density of the impedance points 804 for the different modulation scheme 118 as compared to the previous modulation scheme 118.

Implementations of the process 1300 can further involve establishing impedances to communicate information 910 from the subordinate wireless apparatus 104 to the primary wireless apparatus 102. For example, the reflection of the backscatter signal at block 1308 can include establishing an impedance at the subordinate wireless apparatus 104 in accordance with an impedance point 804 of the modulation scheme 118. More specifically, the establishment of the impedance may include changing a series capacitance that is coupled in series with an inductor of a transceiver assembly 114 of the subordinate wireless apparatus 104 or changing a parallel capacitance that is coupled in parallel with the inductor of the transceiver assembly 114. Additionally or alternatively, the establishment of the impedance may include changing an operational timing of a rectifier 612 to change a phase of the backscatter signal 108 relative to a phase of the power transmission 312.

Implementations for adaptive backscatter modulation are applicable to many different types of wireless backscatter communications systems, including those realized with wireless power transfer devices. Examples of devices that transmit or receive power wirelessly include toothbrushes to smart phones and medical devices to vehicles. A wireless charging system is described below in the context of vehicles. However, the described principles are applicable to other types of wireless charging environments beyond those of vehicles.

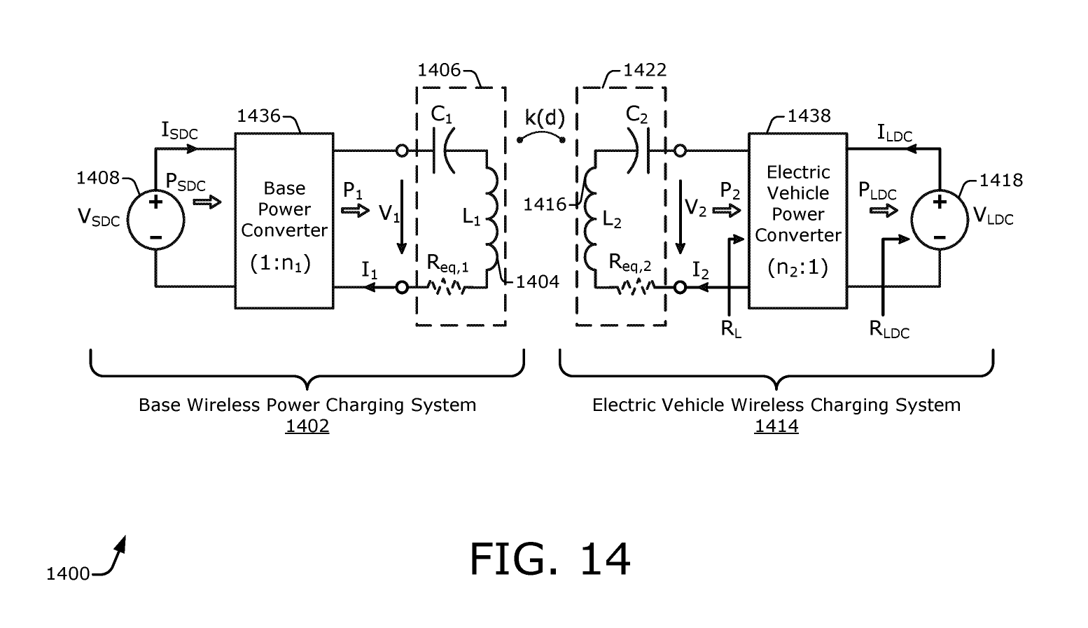

FIG. 14 is a schematic diagram of example components of a wireless power transfer system 1400, which is similar to that discussed above in connection with FIG. 4, but is described in terms of an example vehicular implementation. The wireless power transfer system 1400 also includes additional example components, and the description below includes additional associated operations. As shown, the wireless power transfer system 1400 includes a base wireless power charging system 1402 and an electric vehicle wireless charging system 1414. The base wireless power charging system 1402 includes a base resonant circuit 1406 that includes a base coupler 1404 having an inductance L₁. The electric vehicle wireless charging system 1414 includes an electric vehicle resonant circuit 1422 that includes an electric vehicle coupler 1416 having an inductance L₂. To implement adaptive backscatter modulation in the wireless power transfer system 1400, the base wireless power charging system 1402 can include modulation control circuitry 202 (e.g., of FIGS. 2, 3, and 10), and the electric vehicle wireless charging system 1414 can include modulation control circuitry 204 (e.g., of FIGS. 2, 3, 9, and 10). For example, the electric vehicle resonant circuit 1422 can include an adjustable impedance circuit 606 (e.g., of FIGS. 6 and 9). Although some of the example details provided herein with reference to FIG. 14 are described in terms of a vehicular wireless charging environment, the principles described with reference to FIG. 14 are also applicable to other implementations, such as the wireless charging of portable electronic devices.

Implementations described herein may use capacitively loaded conductor loops (e.g., multi-turn coils) forming a resonant structure that is capable of efficiently coupling energy from a primary structure (or transmitter) to a subordinate structure (or receiver) via a magnetic or electromagnetic near-field, at least if both the transmitter and the receiver are tuned to a common resonant frequency. The coils may be used for the electric vehicle coupler 1416 and the base coupler 1404. Using resonant structures for coupling energy may be referred to as “magnetically coupled resonance,” “electromagnetically coupled resonance,” or “resonant induction.” The operation of the wireless power transfer system 1400 is described based on power transfer from a base coupler 1404 to an electric vehicle (not shown), but operation is not limited thereto. For example, as discussed above, energy may also be transferred in the reverse direction or in a non-vehicular environment, such as smart phone or other portable electronic device.

With reference to FIG. 14, a power supply 1408 (e.g., AC or DC) supplies power P_{SDC} to the base power converter 1436 as part of the base wireless power charging system 1402 to transfer energy to an electric vehicle. The base power converter 1436 may include circuitry such as an AC-to-DC converter configured to convert power from standard mains AC to DC power at a suitable voltage level, and a DC-to-low frequency (LF) converter configured to convert DC power to power at an operating frequency suitable for wireless high power transfer. The base power converter 1436 supplies power P₁ to the base resonant circuit 1406, which includes a tuning capacitor C₁ coupled in series with the base coupler 1404 to emit an electromagnetic field at the operating frequency. The series-tuned resonant circuit 1406 depicts one example. In another implementation, the capacitor tuning C₁ may be coupled with the base coupler 1404 in parallel. Alternatively, tuning may be realized with multiple reactive elements in any combination of parallel or series topology. The tuning capacitor C₁ may be provided to form a resonant circuit with the base coupler 1404 that resonates substantially at the operating frequency. The base coupler 1404 receives the power P₁ and wirelessly transmits power at a level sufficient to charge or power the electric vehicle. For example, the level of power provided wirelessly by the base coupler 1404 may be on the order of kilowatts (kW) for a vehicular charging environment (e.g., anywhere from 1 kW to 110 kW, although actual levels may be or higher or lower).

The base resonant circuit 1406 (including the base coupler 1404 and the tuning capacitor C₁) and the electric vehicle resonant circuit 1422 (including the electric vehicle coupler 1416 and a tuning capacitor C₂) may be tuned to substantially the same frequency. The electric vehicle coupler 1416 may be positioned within the near-field of the base coupler and vice versa, as further explained below. In such cases, the base coupler 1404 and the electric vehicle coupler 1416 may become coupled to one another such that power may be transferred wirelessly from the base coupler 1404 to the electric vehicle coupler 1416. The tuning capacitor C₂ may be provided to form a resonant circuit with the electric vehicle coupler 1416 that resonates substantially at the operating frequency. The series-tuned resonant circuit 1422 depicts one example. In another implementation, the tuning capacitor C₂ may be coupled with the electric vehicle coupler 1416 in parallel. Alternatively, the electric vehicle resonant circuit 1422 may be realized with multiple reactive elements in any combination of parallel or series topology. Element “k(d)” represents the mutual coupling coefficient resulting from a coil separation of distance “d.” Equivalent resistances R_{eq,1} and R_{eq,2} represent the losses that may be inherent to the base and electric vehicle couplers 1404 and 1416 and the tuning (anti-reactance) capacitors C₁ and C₂, respectively. The electric vehicle resonant circuit 1422, including the electric vehicle coupler 1416 and the tuning capacitor C₂, receives power P₂ wirelessly from the base resonant circuit 1406. The electric vehicle resonant circuit 1422 then provides the power P₂ to an electric vehicle power converter 1438 of the electric vehicle wireless charging system 1414.

The electric vehicle power converter 1438 may include, among other things, a LF-to-DC converter configured to convert power at a wireless transfer operating frequency back to DC power at a voltage level of an electric vehicle load 1418, which may represent an electric vehicle battery unit or other power store. The electric vehicle power converter 1438 may provide the converted power P_{LDC} to the load 1418 to charge the electric vehicle battery unit. The power supply 1408, the base power converter 1436, and the base coupler 1404 may be stationary and located at a variety of locations. The electric vehicle load 1418, the electric vehicle power converter 1438, and the electric vehicle coupler 1416 may be included in the electric vehicle wireless charging system 1414 that is part of the electric vehicle or part of a battery pack for the electric vehicle. The electric vehicle wireless charging system 1414 may also be configured to provide power wirelessly through the electric vehicle coupler 1416 to the base wireless power charging system 1402 to feed power back to the grid or other power supply 1408 or to increase a size of a modulation constellation for a modulation scheme. Further, each of the electric vehicle coupler 1416 and the base coupler 1404 may act as transmit or receive couplers based on the mode of operation.

Although not shown, the wireless power transfer system 1400 may include a load disconnect unit (LDU) to safely disconnect the electric vehicle load 1418 or the power supply 1408 from the remainder of the wireless power transfer system 1400. For example, in case of an emergency or system failure, the LDU may be triggered to disconnect the load from the wireless power transfer system 1400. The LDU may be provided in addition to a battery management system for managing the charging of a battery, or the LDU may be part of the battery management system.

Further, the electric vehicle wireless charging system 1414 may include switching circuitry (not shown) for selectively connecting and disconnecting the electric vehicle coupler 1416 to the electric vehicle power converter 1438. Disconnecting the electric vehicle coupler 1416 may suspend charging and also may change the “load” as “seen” by the base wireless power charging system 1402 (acting as a transmitter). This disconnection can be used to “cloak” the electric vehicle wireless charging system 1414 (acting as the receiver) from the base wireless charging system 1402 or to signal the base wireless charging system 1402. The load changes may be detected if the transmitter includes a load sensing circuit. Accordingly, the transmitter, such as the base wireless charging system 1402, may have a mechanism for determining when receivers, such as the electric vehicle wireless charging system 1414, are present in the near-field coupling mode region of the base coupler 1404 as further explained below.

As described above, in operation during energy transfer towards an electric vehicle, input power is provided from the power supply 1408 such that the base coupler 1404 generates an electromagnetic field for providing the energy transfer. The electric vehicle coupler 1416 couples to the electromagnetic field and generates output power for storage or consumption by the electric vehicle wireless charging system 1414. As described above for some implementations, the base resonant circuit 1406 and the electric vehicle resonant circuit 1422 are configured and tuned according to a mutual resonant relationship such that both are resonating nearly or substantially at the targeted operating frequency. Transmission losses between the base wireless power charging system 1402 and the electric vehicle wireless charging system 1414 are reduced if the electric vehicle coupler 1416 is located in the near-field coupling mode region of the base coupler 1404.

As stated, an efficient energy transfer occurs by transferring energy via a magnetic near-field rather than via electromagnetic waves in the far field, which may involve substantial losses due to radiation into the space. When in the near-field, a coupling mode may be established between the transmit coupler and the receive coupler. The space around the couplers where this near-field coupling may occur is referred to herein as a near-field coupling mode region.

Although not shown, the base power converter 1436 and the electric vehicle power converter 1438 may both include (if bidirectional), for the transmit mode: an oscillator, a driver circuit such as a power amplifier, and a filter and matching circuit; and for the receive mode: a rectifier circuit. The oscillator may be configured to generate a desired operating frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance as presented by the resonant circuits 1406 and 1422 to the base and electric vehicle power converters 1436 and 1438, respectively. For the receive mode, the base and electric vehicle power converters 1436 and 1438 may also include a rectifier and switching circuitry.

The electric vehicle coupler 1416 and the base coupler 1404 as described throughout the disclosed implementations may be referred to or configured as “conductor loops,” and more specifically, as “multi-turn conductor loops” or coils. The base and electric vehicle couplers 1404 and 1416 may also be referred to herein or be configured as “magnetic” couplers. The term “coupler” is intended to refer to a component that may wirelessly output or receive energy for coupling to another “coupler.” As discussed above, efficient transfer of energy between a transmitter and receiver occurs during matched or nearly matched resonance between a transmitter and a receiver. However, even if resonance between a transmitter and receiver are not matched, energy may be transferred at a lower efficiency level.

A resonant frequency may be based on the inductance and capacitance of a resonant circuit (e.g., resonant circuit 1406) including a coupler (e.g., the base coupler 1404 and the tuning capacitor C₂) as described above. As shown in FIG. 14, inductance may generally be the inductance of the coupler, whereas capacitance may be added to the coupler to create a resonant structure at a desired resonant frequency. Accordingly, for larger size couplers using larger diameter coils exhibiting larger inductance, the value of a capacitance employed to produce a particular resonance may be lower. Inductance may also depend on a number of turns of a coil. Furthermore, as the size of the coupler increases, coupling efficiency may increase. This is particularly true if the size of both the base and electric vehicle couplers increase. Furthermore, a resonant circuit including a coupler and a tuning capacitor may be designed to have a high quality (Q) factor to improve energy transfer efficiency or information communication. For example, the Q factor may be 300 or greater.

As described above for some implementations, coupling power between two couplers that are in the near-field of one can be attained. The near-field may correspond to a region around the coupler in which mainly reactive electromagnetic fields exist. If the physical size of the coupler is much smaller than the wavelength, inversely proportional to the frequency, there is no substantial loss of power due to waves propagating or radiating away from the coupler. Near-field coupling-mode regions may correspond to a volume that is near the physical volume of the coupler, typically within a small fraction of the wavelength. According to some implementations, magnetic couplers, such as single and multi-turn conductor loops, are used for both transmitting and receiving because handling magnetic fields in practice is easier than electric fields. This is so because there is less interaction with foreign objects, e.g., dielectric objects and the human body, with magnetic fields. Nevertheless, “electric” couplers (e.g., dipoles and monopoles) or a combination of magnetic and electric couplers may be used.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

1. A wireless apparatus comprising:
a transceiver assembly configured to receive a power transmission from another wireless apparatus via an inductive coupling link;
coupling analysis circuitry configured to determine an inductive coupling quality of the inductive coupling link;
modulation determination circuitry configured to determine a modulation scheme from multiple modulation schemes based on the inductive coupling quality; and
modulation application circuitry configured to adjust an impedance in accordance with the modulation scheme, the transceiver assembly further configured to reflect a backscatter signal across the inductive coupling link based on the impedance adjusted in accordance with the modulation scheme.

2. The wireless apparatus of claim 1, wherein the coupling analysis circuitry is configured to determine the inductive coupling quality based on a measurement of an electrical or magnetic value in the transceiver assembly.

3. The wireless apparatus of claim 2, wherein:
the inductive coupling quality is dependent on an inductive coupling constant of the inductive coupling link between the wireless apparatus and the other wireless apparatus; and
the modulation determination circuitry is configured to determine the modulation scheme from the multiple modulation schemes based on the inductive coupling constant.

4. The wireless apparatus of claim 3, wherein:
the inductive coupling constant is based on a mutual inductance between the wireless apparatus and the other wireless apparatus; and
the coupling analysis circuitry is configured to estimate the mutual inductance based on the measurement of the electrical or magnetic value in the transceiver assembly.

5. The wireless apparatus of claim 4, wherein:
the transceiver assembly includes an inductor;
the mutual inductance arises between the inductor of the wireless apparatus and another inductor of the other wireless apparatus;
the measurement of the electrical or magnetic value in the transceiver assembly comprises an open circuit voltage of the transceiver assembly; and
the coupling analysis circuitry is configured to estimate the mutual inductance based on the open circuit voltage.

6. The wireless apparatus of claim 1, wherein the inductive coupling quality is based on an error rate of at least one backscatter signal reflected from the transceiver assembly to the other wireless apparatus.

7. The wireless apparatus of claim 1, wherein:
the multiple modulation schemes include a first modulation scheme and a second modulation scheme;
the modulation determination circuitry is configured to determine to switch from the first modulation scheme to the second modulation scheme based on the inductive coupling quality; and
a second modulation constellation corresponding to the second modulation scheme is diminished relative to a first modulation constellation corresponding to the first modulation scheme.

8. The wireless apparatus of claim 7, wherein the second modulation constellation is diminished relative to the first modulation constellation by at least one of:
a second range of impedances across an in-phase/quadrature plane (I-Q plane) for the second modulation constellation is smaller than a first range of impedances across the I-Q plane for the first modulation constellation;
a second number of impedance points for the second modulation constellation is less than a first number of impedance points for the first modulation constellation; or
a second density of impedance points for the second modulation constellation is lower than a first density of impedance points for the first modulation constellation.

9. The wireless apparatus of claim 1, further comprising:
a power store coupled to the transceiver assembly,
wherein the modulation determination circuitry is configured to determine the modulation scheme from the multiple modulation schemes based on a power store level of the power store.

10. The wireless apparatus of claim 1, wherein the modulation scheme includes a modulation constellation having multiple impedance points on an in-phase/quadrature (I-Q) plane, each impedance point corresponding to a particular impedance of multiple impedances.

11. The wireless apparatus of claim 10, wherein the modulation application circuitry comprises:
an adjustable impedance circuit configurable to establish the multiple impedances; and
impedance control circuitry configured to establish the particular impedance of each impedance point using the adjustable impedance circuit in accordance with the modulation scheme.

12. The wireless apparatus of claim 11, wherein:
the adjustable impedance circuit includes multiple components that are separately or jointly configurable to establish the multiple impedances, at least some of the multiple impedances having a non-zero resistance and a non-zero reactance; and
the impedance control circuitry is configured to establish an impedance of each impedance point by manipulating one or more of the multiple components in accordance with the modulation scheme, the impedance control circuitry further configured to adjust a resistance and a reactance of the adjustable impedance circuit to establish the particular impedance for a corresponding impedance point of the multiple impedance points.

13. The wireless apparatus of claim 11, wherein:
the adjustable impedance circuit includes a receiver inductor; and
the impedance control circuitry is configured to drive the receiver inductor with current to induce a voltage at a transmitter inductor at the other wireless apparatus to establish an impedance point of the multiple impedance points.

14. The wireless apparatus of claim 11, wherein:
the adjustable impedance circuit includes a rectifier; and
the impedance control circuitry includes a rectifier controller configured to change an operational timing of the rectifier to establish at least one impedance of the multiple impedances.

15. The wireless apparatus of claim 14, wherein the rectifier controller is configured to change the operational timing of the rectifier to establish at least one negative resistance for the multiple impedances.

16. The wireless apparatus of claim 11, wherein:
the adjustable impedance circuit includes at least one capacitor; and
the impedance control circuitry is configured to activate the capacitor to establish at least one impedance of the multiple impedances.

17. A method for a subordinate wireless apparatus to adaptively modulate backscatter signaling, the method comprising:
receiving a power transmission from a primary wireless apparatus via an inductive coupling link;
determining an inductive coupling quality of the inductive coupling link;
determining a modulation scheme from multiple modulation schemes based on the inductive coupling quality; and
reflecting, based on the modulation scheme, a backscatter signal across the inductive coupling link using the power transmission, including establishing an impedance at the subordinate wireless apparatus in accordance with an impedance point of the modulation scheme.

18. The method of claim 17, wherein:
the inductive coupling quality is dependent on an inductive coupling constant of the inductive coupling link between the primary wireless apparatus and the subordinate wireless apparatus; and
the determining the modulation scheme comprises determining the modulation scheme from the multiple modulation schemes based on the inductive coupling constant.

19. The method of claim 18, wherein:
the inductive coupling constant is dependent on a mutual inductance between the primary wireless apparatus and the subordinate wireless apparatus; and
the determining the modulation scheme based on the inductive coupling constant comprises determining the modulation scheme from the multiple modulation schemes based on the mutual inductance.

20. The method of claim 17, wherein the determining the inductive coupling quality comprises determining the inductive coupling quality based on test information that is related to communication error.

21. The method of claim 17, wherein:
the modulation scheme includes a modulation constellation having multiple impedance points, each impedance point corresponding to a location on an in-phase/quadrature (I-Q) plane; and
the reflecting comprises reflecting, using at least a portion of the multiple impedance points, the backscatter signal across the inductive coupling link using the power transmission.

22. The method of claim 21, wherein the determining the modulation scheme comprises switching to a different modulation scheme of the multiple modulation schemes by at least one of:
reducing a number of impedance points for the different modulation scheme;
reducing a density of impedance points for the different modulation scheme; or
reducing a range of impedances available for the different modulation scheme.

23. The method of claim 17, wherein the establishing comprises changing an operational timing of a rectifier to change a phase of the backscatter signal relative to the power transmission.

24. A wireless apparatus comprising:
a power store configured to provide or receive power;
a transceiver assembly configured to receive a power transmission from another wireless apparatus that has an inductive coupling link with the wireless apparatus at some inductive coupling quality, the transceiver assembly configured to provide to the power store power received via the power transmission, the transceiver assembly further configured to reflect a backscatter signal across the inductive coupling link based on an impedance adjusted in accordance with a modulation scheme; and
means for controlling the modulation scheme based on the inductive coupling quality to adjust a communication bandwidth between the wireless apparatus and the other wireless apparatus, the means for controlling the modulation scheme including:
means for analyzing the inductive coupling link to compute the inductive coupling quality; and
means for determining the modulation scheme from multiple modulation schemes based on the inductive coupling quality.

25. (canceled)

26. (canceled)

27. The wireless apparatus of claim 24, wherein the means for controlling the modulation scheme includes means for applying the modulation scheme using an adjustable impedance circuit.

28. A wireless apparatus comprising:
a transceiver assembly configured to generate a power transmission and receive a backscatter signal reflected using the power transmission via an inductive coupling link, the backscatter signal carrying information based on a modulation scheme; and
a transceiver controller configured to:
analyze the backscatter signal to produce detected impedances respectively corresponding to impedance points in accordance with the modulation scheme; and
process the impedance points based on the modulation scheme to recover the information, wherein:
the transceiver controller includes modulation control circuitry configured to compute an error indication based on the information recovered by the transceiver controller;
the transceiver controller is configured to cause the transceiver assembly to generate another power transmission, the other power transmission including the error indication; and
the modulation control circuitry is configured to cause the transceiver controller to change to a different modulation scheme of multiple modulation schemes based on the error indication to process other impedance points from another backscatter signal.

29. (canceled)

30. The wireless apparatus of claim 28, wherein the transceiver assembly comprises:
a transmit loop configured to generate the power transmission; and
a receive loop configured to receive the backscatter signal that is reflected using the power transmission via the inductive coupling link.

31. The wireless apparatus of claim 27, wherein the adjustable impedance circuit comprises:
an inductor;
a capacitor coupled in parallel with the inductor; and
a rectifier coupled to the capacitor.

32. The wireless apparatus of claim 31, wherein:
the rectifier comprises multiple transistors; and
the means for applying the modulation scheme includes means for controlling an impedance of the adjustable impedance circuit by changing an operational timing of the multiple transistors of the rectifier.

33. The wireless apparatus of claim 30, wherein the modulation control circuitry comprises:
a signal recovery unit having a first input and a second input; the first input coupled to an output of the receive loop, and the second input coupled to an input of the transmit loop; the signal recovery unit configured to recover a magnitude and a phase of information carried on the backscatter signal using the first input and the second input.
